(19) United States
(12) Patent Application Publication
(10) Pub. No.: US 2026/0261612 A1
(43) Pub. Date: Sep. 3, 2026

(54) ELECTRONIC DEVICE, METHOD, AND NON-TRANSITORY COMPUTER READABLE STORAGE MEDIUM FOR CONTROLLING EXTERNAL ELECTRONIC DEVICE

(71) Applicant: Samsung Electronics Co., Ltd., Suwon-si (KR)

(72) Inventors: Seungcheol LEE, Suwon-si (KR); Kyoungho CHOI, Suwon-si (KR); Dongeup HAM, Suwon-si (KR); Hojeen JEE, Suwon-si (KR); Heejun LEE, Suwon-si (KR); Jangwoo LEE, Suwon-si (KR); Jongha WOO, Suwon-si (KR); Inhyun YANG, Suwon-si (KR); Taeyong PARK, Suwon-si (KR); Junhyung PARK, Suwon-si (KR); Soonhyeong KWON, Suwon-si (KR); Chinok KO, Suwon-si (KR)

(21) Appl. No.: 19/404,691

(22) Filed: Dec. 1, 2025

Related U.S. Application Data
(63) Continuation of application No. PCT/KR2025/018109, filed on Nov. 6, 2025.

(30) Foreign Application Priority Data
Feb. 28, 2025 (KR) 10-2025-0027078
Apr. 24, 2025 (KR) 10-2025-0053642

(51) Int. Cl. H04M 1/72415; H04W 76/14

(52) U.S. Cl. CPC H04M 1/72415; H04W 76/14

(57) ABSTRACT

An electronic device includes communication circuitry, memory storing instructions, and at least one processor comprising processing circuitry. The instructions, when executed by the at least one processor, cause the electronic device to receive a user input for controlling an external electronic device, identify whether a communication link is not established between the electronic device and the external electronic device, based on identifying that the communication link is not established, broadcast an advertising packet, including a control command, identification information of the external electronic device, and a connection request for establishing the communication link, for allowing the external electronic device to provide a function corresponding to the control command before the communication link is established, and based on identifying that the communication link has been established, transmit, to the external electronic device, via the communication link, a packet including the control command.

### CROSS-REFERENCE TO RELATED APPLICATION(S)

This application is a continuation application, claiming priority under 35 U.S.C. § 365(c), of an International application No. PCT/KR 2025/018109, filed on Nov. 6, 2025, which is based on and claims the benefit of a Korean patent application number 10-2025-0027078, filed on Feb. 28, 2025, in the Korean Intellectual Property Office, and of a Korean patent application number 10-2025-0053642, filed on Apr. 24, 2025, in the Korean Intellectual Property Office, the disclosure of each of which is incorporated by reference herein in its entirety.

### TECHNICAL FIELD

The disclosure relates to an electronic device, a method, and a non-transitory computer-readable storage medium for controlling an external electronic device.

### BACKGROUND ART

An electronic device may be used to control an external electronic device. For example, the electronic device may include communication circuitry. For example, the electronic device may transmit a control command through the communication circuitry so that the control command is transmitted to the external electronic device. For example, the electronic device may control the external electronic device through a server device. For example, the external electronic device may be registered in the server device as associated with the electronic device. For example, the electronic device may transmit the control command to the server device through the communication circuitry. For example, the control command may be transmitted to the external electronic device through the server device.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide an electronic device, a method, and a non-transitory computer-readable storage medium for controlling an external electronic device.

Additional aspects will be set forth in part in the description which follows and, in part, will be apparent from the description, or may be learned by practice of the presented embodiments.

In accordance with an aspect of the disclosure, an electronic device is provided. The electronic device may include communication circuitry. The electronic device may include memory comprising one or more storage media storing instructions. The electronic device may include at least one processor comprising processing circuitry. The instructions, when executed by the at least one processor individually or collectively, may cause the electronic device to receive a user input for controlling an external electronic device registered in the electronic device. The instructions, when executed by the at least one processor individually or collectively, may cause the electronic device to identify whether a communication link is not established between the electronic device and the external electronic device. The instructions, when executed by the at least one processor individually or collectively, may cause the electronic device to, based on identifying that the communication link is not established between the electronic device and the external electronic device, broadcast an advertising packet, including a control command generated in accordance with the user input, identification information of the external electronic device, and a connection request for establishing the communication link between the electronic device and the external electronic device, for allowing the external electronic device to provide a function corresponding to the control command before the communication link is established. The instructions, when executed by the at least one processor individually or collectively, may cause the electronic device to, based on identifying that the communication link has been established between the electronic device and the external electronic device, transmit, using the communication circuitry to the external electronic device, via the communication link, a packet including the control command generated in accordance with the user input.

In accordance with an aspect of the disclosure, a method performed by an electronic device with communication circuitry is provided. The method may include receiving a user input for controlling an external electronic device registered in the electronic device. The method may include identifying whether a communication link is not established between the electronic device and the external electronic device. The method may include, based on identifying that the communication link is not established between the electronic device and the external electronic device, broadcasting an advertising packet, including a control command generated in accordance with the user input, identification information of the external electronic device, and a connection request for establishing the communication link between the electronic device and the external electronic device, for allowing the external electronic device to provide a function corresponding to the control command before the communication link is established. The method may include, based on identifying that the communication link has been established between the electronic device and the external electronic device, transmitting, using the communication circuitry to the external electronic device, via the communication link, a packet including the control command generated in accordance with the user input.

In accordance with an aspect of the disclosure, one or more non-transitory computer readable storage media is provided. The one or more non-transitory computer readable storage media may store one or more computer programs. The one or more computer programs may include computer-executable instructions that, when executed by at least one processor of an electronic device with communication circuitry individually or collectively, cause the electronic device to perform operations. The operations may include receiving a user input for controlling an external electronic device registered in the electronic device. The operations may include identifying whether a communication link is not established between the electronic device and the external electronic device. The operations may include based on identifying that the communication link is not established between the electronic device and the external electronic device, broadcasting an advertising packet, including a control command generated in accordance with the user input, identification information of the external electronic device, and a connection request for establishing the communication link between the electronic device and the external electronic device, for allowing the external electronic device to provide a function corresponding to the control command before the communication link is established. The operations may include based on identifying that the communication link has been established between the electronic device and the external electronic device, transmitting, using the communication circuitry to the external electronic device, via the communication link, a packet including the control command generated in accordance with the user input.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 illustrates an example of components of an electronic device for controlling an external electronic device according to an embodiment of the disclosure;

FIG. 3 illustrates an example of a simplified block diagram of an electronic device according to an embodiment of the disclosure;

FIG. 4A illustrates an example of an electronic device that adaptively controls an external electronic device according to whether a communication link has been established between the electronic device and the external electronic device according to an embodiment of the disclosure;

FIG. 4B illustrates an example of operations of an electronic device that adaptively controls an external electronic device according to whether a communication link has been established between the electronic device and the external electronic device according to an embodiment of the disclosure;

FIG. 5 illustrates an example in which a communication link is established between an electronic device and an external electronic device after the external electronic device provides a function corresponding to a control command according to an embodiment of the disclosure;

FIG. 6 illustrates an example of an advertising packet broadcasted by each of an electronic device and an external electronic device according to an embodiment of the disclosure;

FIG. 7 illustrates an example of an electronic device that adaptively controls an external electronic device according to a distance between the electronic device and the external electronic device according to an embodiment of the disclosure;

FIG. 8 illustrates an example of an electronic device that executes an application for controlling an external electronic device according to an embodiment of the disclosure;

FIG. 9 illustrates an example of a visual object for controlling an external electronic device according to an embodiment of the disclosure;

FIG. 10 illustrates an example of operations of an electronic device for controlling an external electronic device when a communication link is not established between the electronic device and the external electronic device according to an embodiment of the disclosure;

FIG. 11 illustrates an example of operations of an electronic device for controlling an external electronic device when a communication link is not established between the electronic device and the external electronic device according to an embodiment of the disclosure; and

FIG. 12 illustrates an example of operations in which an external electronic device is registered in each of an electronic device and a server device according to an embodiment of the disclosure.

The same reference numerals are used to represent the same elements throughout the drawings.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various embodiments of the disclosure described below, a hardware approach will be described as an example. However, since the various embodiments of the disclosure include technology that uses both hardware and software, the various embodiments of the disclosure do not exclude a software-based approach.

A term referring to data (e.g., packet, advertising packet, data, information, signal, connection request, control command, or identification information), a term referring to a value (e.g., reference distance, reference amount, or reference intensity), a term for a calculation state (e.g., operation, or process), a term referring to an object (e.g., visual object, or icon), a term referring to a network entity, and a term referring to a component of a device, and the like, that are used in the following description, are exemplified for convenience of explanation. Therefore, the disclosure is not limited to terms to be described below, and another term having an equivalent technical meaning may be used. In addition, a term such as ‘. . . unit’, ‘. . . device’, ‘. . . object’, and ‘. . . structure’, and the like used below may mean at least one shape structure or may mean a unit processing a function.

In addition, in the disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to ’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’ or ‘D’, that is, {‘C’, ‘D’, and ‘C’and ‘D’}.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

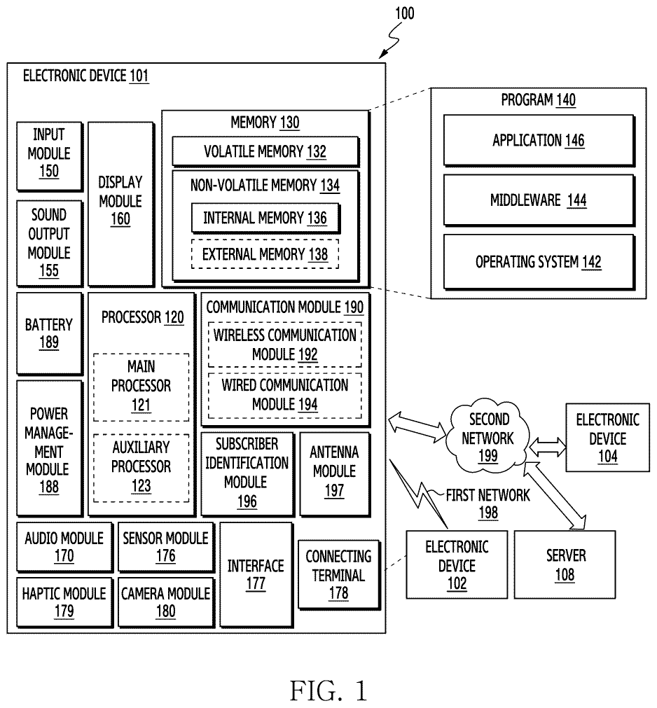

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. The processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. In an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. In an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. The communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to some embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

Commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. The external electronic device 104 or the server 108 may be included in the second network 199. The electronic device 101 may be applied to intelligent services (e.g., smart home, smart city, smart car, or healthcare) based on 5G communication technology or IoT-related technology.

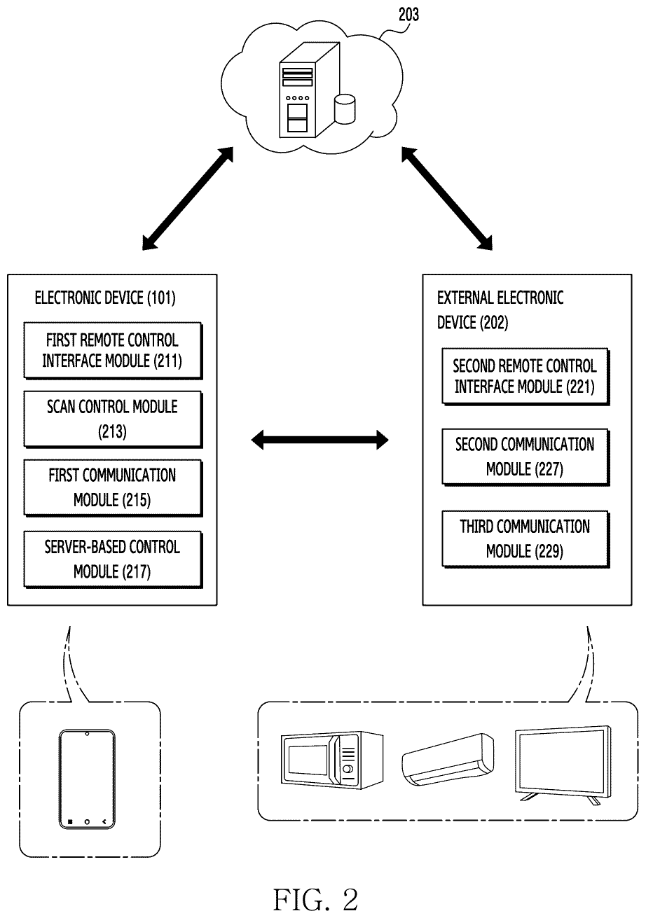

FIG. 2 illustrates an example of components of an electronic device for controlling an external electronic device according to an embodiment of the disclosure.

An electronic device 101 may be one of various types of mobile devices, such as a laptop, smartphones having various form factors (e.g., a bar-type smartphone, a foldable-type smartphone, a multi foldable-type smartphone, or a rollable-type smartphone), a tablet, a cellular phone, and other similar computing devices. The electronic device 101 may be referred to as a user device, a multifunctional device, or a portable device.

Referring to FIG. 2, the electronic device 101 may include components for controlling an external electronic device 202. For example, the electronic device 101 may include a first remote control interface module 211, a scan control module 213, a first communication module 215, and/or a server-based control module 217.

The first remote control interface module 211 may be used to control the external electronic device 202. For example, the first remote control interface module 211 may be used to obtain or generate a control command for controlling the external electronic device 202. For example, the control command may be included in a packet. For example, the first remote control interface module 211 may be used to generate the packet including the control command.

The first remote control interface module 211 may be used to establish a communication link between the electronic device 101 and the external electronic device 202. For example, establishing the communication link may include establishing or establishing a wireless connection. In an example, the established communication link may be used for a data exchange between the electronic device 101 and the external electronic device 202. For example, the electronic device 101 may transmit the control command to the external electronic device 202 through the communication link. For example, the electronic device 101 may receive a response signal from the external electronic device 202 through the communication link.

According to an embodiment, the external electronic device 202 may be registered in the electronic device 101. For example, the electronic device 101 may establish the communication link between the electronic device 101 and the external electronic device 202 according to a position of the electronic device 101 and a position of the external electronic device 202 using the first remote control interface module 211. For example, the electronic device 101 may identify intensity of a signal broadcasted from the external electronic device 202. The electronic device 101 may identify a distance between the electronic device 101 and the external electronic device 202 according to the intensity of the signal. For example, the electronic device 101 may establish the communication link between the electronic device 101 and the external electronic device 202 based on identifying that the distance is less than a reference distance.

According to an embodiment, the electronic device 101 may identify strength of each of signals broadcasted from a plurality of external electronic devices (e.g., including the external electronic device 202). For example, the electronic device 101 may determine an external electronic device (e.g., the external electronic device 202) closest to the electronic device 101 among the plurality of external electronic devices based on each of the broadcasted signals. For example, the electronic device 101 may establish a communication link between the electronic device 101 and the external electronic device (e.g., the external electronic device 202) closest to the electronic device 101.

According to an embodiment, a data exchange may be performed between the electronic device 101 and the external electronic device 202 according to a Generic Attribute Profile (GATT) protocol. For example, the electronic device 101 may transmit a control command to the external electronic device through a communication link according to the GATT protocol. The communication link between the electronic device 101 and the external electronic device 202 may be established according to Bluetooth low energy (BLE). For example, the communication link may include a communication link for a BLE physical connection and/or a communication link for a GATT connection. For example, the first remote control interface module 211 may be referred to as a BLE remote. For example, in terms of the electronic device 101 transmitting the control command, the first remote control interface module 211 may be used to perform a role of a GATT client. However, an embodiment is not limited thereto. As a non-limiting example, the first remote control interface module 211 may be used to perform a role of a GATT server. For example, the electronic device 101 may transmit the control command to the external electronic device 202 as a GATT notification by using the first remote control interface module 211.

According to an embodiment, the first remote control interface module 211 may be used to perform authentication for checking whether the external electronic device 202 is a reliable device. In an example, the first remote control interface module 211 may be used to identify whether the external electronic device 202 is a device registered in the electronic device 101. For example, the first remote control interface module 211 may be used to identify or verify whether a packet received by the electronic device 101 has been transmitted from the external electronic device 202 registered in the electronic device 101. For example, the first remote control interface module 211 may be used to perform reliability verification between the electronic device 101 and the external electronic device 202. For example, the first remote control interface module 211 may be used to generate a public key and/or a private key of the electronic device 101. For example, the first remote control interface module 211 may be used to generate a security key (e.g., a session key) shared between the electronic device 101 and the external electronic device 202.

According to an embodiment, the first remote control interface module 211 may be configured to expand a function of the first remote control interface module 211 through a plug-in function.

The scan control module 213 may be used to control, adjust, or change a period of a scan of the electronic device 101. For example, the scan (or scanning) may be referred to as an operation of searching for the external electronic device 202 that broadcasts an advertising packet. The period of the scan may be configured with a scan interval and a scan window. The scan interval may be referred to as a period at which the scan starts. For example, the scan window may be referred to as a time interval at which the scan is performed within a scan period. For example, the scan control module 213 may be used to change a setting value of the scan interval and/or a setting value of the scan window. For example, according to whether a control application (or an IOT application) for controlling the external electronic device 202 is being executed in a foreground (or a foreground state) of the electronic device 101, the scan control module 213 may control, adjust, or change a scan duty. For example, the scan duty may indicate a ratio of the scan window with respect to the scan interval. For example, a value of the scan duty set while the control application is being executed in the foreground of the electronic device 101 may be greater than a value of the scan duty set while the control application is not being executed in the foreground of the electronic device 101.

The first communication module 215 may be used to transmit a control command to the external electronic device 202. For example, the first communication module 215 may include communication circuitry for BLE, but the embodiment is not limited thereto. The first communication module 215 may be used to receive the advertising packet broadcasted from the external electronic device 202. For example, at least the part of the communication module 190 of FIG. 1 may correspond to the first communication module 215.

The server-based control module 217 may be used for the electronic device 101 to communicate with a server device 203. For example, the server-based control module 217 may include communication circuitry for communicating with the server device 203. For example, the electronic device 101 may transmit a request signal for transmitting a control command to the external electronic device 202 through the server device 203, to the server device 203 using the server-based control module 217. For example, the request signal may include the control command. In an example, the server device 203 may transmit the control command transmitted from the electronic device 101 to the external electronic device 202.

The control command may cause the external electronic device 202 to execute a designated function. For example, the electronic device 101 may change a state of the external electronic device 202 from a turn-off state to a turn-on state through the server device 203. The electronic device 101 may change the state of the external electronic device 202 from a sleep state (or an inactivation state) to an active state through the server device 203. The external electronic device 202 receiving the control command may transmit or report a response signal with respect to the control command to the server device 203. The response signal may indicate whether a function according to the control command has been executed. The server device 203 may transmit or provide the received response signal to the electronic device 101. For example, the server device 203 may indirectly connect the electronic device 101 and the external electronic device 202.

The server device 203 may register the electronic device 101 and/or the external electronic device 202. For example, the server device 203 may register the electronic device 101 as associated with the external electronic device 202. The server device 203 may provide various services to the electronic device 101. For example, the server device 203 may register the electronic device 101 in a smart service platform (e.g., a platform that serves a smart home and/or a smart city) as associated with the external electronic device 202. The electronic device 101 may provide a function of controlling the external electronic device 202 through the server device 203, a function of managing the external electronic device 202, and a function of monitoring the state of the external electronic device 202. The server device 203 may be used to control and manage the external electronic device 202. For example, the server device 203 may include an intelligent server device using machine learning and/or a neural network. For example, the server device 203 may be an example of the server 108 of FIG. 1. The server device 203 may provide an intelligent service (e.g., a smart home, a smart city, a smart car, or healthcare) based on a technology related to Internet of things (IOT). The server device 203 may be referred to as an IOT server in terms of providing the intelligent service based on the technology related to IOT.

The external electronic device 202 may include a second remote control interface module 221 and/or a second communication module 227. The external electronic device 202 may be an example of the electronic device 102 of FIG. 1. As a non-limiting example, the external electronic device 202 may be an example of the electronic device 104 of FIG. 1. For example, the external electronic device 202 may be referred to as a smart electronic device that provides an IOT service. The external electronic device 202 may include a television, an air conditioner, a range, a microwave, a refrigerators, an air purifiers, a robot cleaner, a humidifier, an oven, a cooktop, a washing machine, a dryer, a dishwasher, an air dresser, a monitor (or a smart monitor), and/or a projector, but the embodiment is not limited thereto.

Since the second remote control interface module 221 may be substantially the same as at least a portion of the first remote control interface module 211, redundant content will be omitted for convenience of explanation. Descriptions of the first remote control interface module 211 may be referenced for the second remote control interface module 221. The second remote control interface module 221 may be used to perform a function according to a control command transmitted from the electronic device 101. For example, the second remote control interface module 221 may be used to process the control command.

Since the second communication module 227 may be substantially the same as at least a portion of the first communication module 215, redundant content will be omitted for convenience of explanation. For example, the external electronic device 202 may broadcast an advertising packet using the second communication module 227. For example, the external electronic device 202 may receive a control command (or a packet including the control command) from the electronic device 101 using the second communication module 227.

A third communication module 229 may be used to receive a control command from the server device 203. For example, the third communication module 229 may include communication circuitry for communicating with the server device 203. As a non-limiting example, the external electronic device 202 may transmit a response signal with respect to the control command to the server device 203 by using the third communication module 229.

According to an embodiment, the electronic device 101 may receive a user input for controlling the external electronic device 202. For example, the electronic device 101 may transmit a control command to the external electronic device 202 based on the user input. For example, the communication link established between the electronic device 101 and the external electronic device 202 may be required to transmit the control command to the external electronic device 202. For example, the electronic device 101 may establish the communication link between the electronic device 101 and the external electronic device 202 before transmitting the control command to the external electronic device. For example, the electronic device 101 may establish the communication link between the electronic device 101 and the external electronic device 202 using the first remote control interface module 211 and/or the first communication module 215 according to the user input received while the communication link between the electronic device 101 and the external electronic device 202 is not being established. For example, after establishing the communication link, the electronic device 101 may transmit the control command to the external electronic device 202 through the communication link using the first remote control interface module 211 and/or the first communication module 215. For example, the external electronic device 202 may receive the control command from the electronic device 101 after the communication link is established. A timing at which the external electronic device 202 provides the function according to the control command may be a timing after a time interval for establishing the communication link between the electronic device 101 and the external electronic device 202 has elapsed from a timing at which the user input is received to the electronic device 101. For example, the time interval for establishing the communication link between the electronic device 101 and the external electronic device 202 may be perceived as a latency by a user. As an example, the time interval for establishing the communication link between the electronic device 101 and the external electronic device 202 may cause inconvenience to the user. A method for reducing a time difference between the timing at which the user input is received to the electronic device 101 and the timing at which the external electronic device 202 provides the function according to the control command may be required.

According to an embodiment, the electronic device 101 may continuously establish the communication link with the external electronic device 202 registered in the electronic device 101. For example, the electronic device 101 continuously establishing the communication link with the external electronic device 202 may include that the electronic device 101 maintains the communication link constantly even during a duration at which the communication link is not substantially utilized. By continuously establishing the communication link with the external electronic device 202, the electronic device 101 may reduce the time difference between the timing at which the user input is received and the timing at which the external electronic device 202 provides the function according to the control command, but power consumption (or a current) of the electronic device 101 and power consumption (or a current) of the external electronic device 202 may relatively increase. In a case that the electronic device 101 continuously establishes the communication link with the external electronic device 202, an amount of use of a battery resource of the electronic device 101 may increase. For example, as the amount of use of the battery resource of the electronic device 101 increases, usable time of the electronic device 101 may be shortened. For example, as the usable time of the electronic device 101 is shortened, it may cause inconvenience to the user of the electronic device 101.

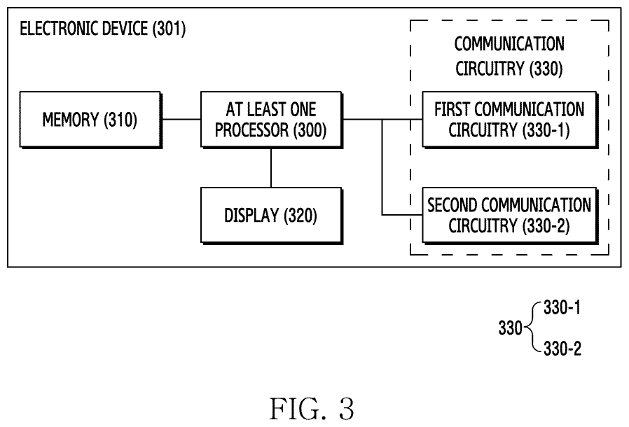

In the disclosure, a method in which the electronic device controls the external electronic device before the communication link is established between the electronic device and the external electronic device is described. For example, the electronic device may control the external electronic device by broadcasting the advertising packet including the control command. For example, the electronic device may store instructions for generating the advertising packet in memory of the electronic device. The electronic device may relatively reduce a time difference between the timing at which the user input is received to the electronic device and a timing at which the external electronic device is controlled by broadcasting the advertising packet including the control command. In addition, in embodiments according to the disclosure, the method in which the electronic device controls the external electronic device before the communication link is established between the electronic device and the external electronic device may not continuously establish the communication link between the electronic device and the external electronic device. For example, the electronic device may establish the communication link only when the communication link is substantially utilized between the electronic device and the external electronic device. The electronic device may relatively reduce the amount of use of the battery resource used by establishing the communication link only when the communication link is substantially utilized between the electronic device and the external electronic device. For example, the electronic device may reduce unnecessary power consumption. In an example, as the amount of use of the battery resource of the electronic device is reduced, the usable time of the electronic device may be extended. For example, as the usable time of the electronic device is extended, user experience of the electronic device may be enhanced. For example, the method in which the electronic device controls the external electronic device before the communication link is established between the electronic device and the external electronic device may be executed in an electronic device 301 of FIG. 3. For example, the electronic device 301 of FIG. 3 may include components (or hardware components) for providing the method. The components will be described and illustrated in more detail with reference to FIG. 3.

FIG. 3 illustrates an example of a simplified block diagram of an electronic device according to an embodiment of the disclosure. An electronic device 301 of FIG. 3 may be an example of the electronic device 101 of FIG. 1.

Referring to FIG. 3, the electronic device 301 may include at least one processor 300, memory 310, a display 320, and/or communication circuitry 330. For example, the at least one processor 300, the memory 310, the display 320, and/or the communication circuitry 330 may be electronically and/or operatively coupled with each other by a communication bus. In the following, hardware components being operatively coupled may mean that a direct or an indirect connection between the hardware components is established by wire or wirelessly so that a second hardware component among the hardware components is controlled by a first hardware component. The hardware components illustrated in FIG. 3 are illustrated based on different blocks, but the disclosure is not limited thereto. For example, a portion (e.g., the at least one processor 300, the memory 310, and the communication circuitry 330) of the hardware components illustrated in FIG. 3 may be included in a single integrated circuit such as a system on chip (SoC) or a system in package (SIP). A type and/or the number of the hardware components included in the electronic device 301 is not limited as illustrated in FIG. 3. For example, the electronic device 301 may include only a portion of the hardware components illustrated in FIG. 3.

The at least one processor 300 may include a hardware component for processing data based on executing instructions. The at least one processor 300 may be configured to execute the instructions stored in the memory 310 individually or collectively. The at least one processor 300 may include processing circuitry. For example, the hardware component for processing data may include an arithmetic and logic unit (ALU), a floating point unit (FPU), and a field programmable gate array (FPGA). For example, the hardware component for processing data may include a central processing unit (CPU), a graphics processing unit (GPU), a display processing unit (DPU), a neural processing unit (NPU), a digital signal processor (DSP), an application processor (AP), and/or a microcontroller (MCU). The at least one processor 300 may include one or more cores. The at least one processor 300 may have a structure of a multi-core processor such as a dual core, a quad core, or a hexa core. The at least one processor 300 of FIG. 3 may be applied in substantially the same manner as the processor 120 of FIG. 1. The at least one processor 300 may be configured to control the memory 310, the display 320, and the communication circuitry 330.

The memory 310 may include a hardware component for storing data and/or instructions inputted to and/or outputted from the at least one processor 300. For example, the instructions may indicate a calculation and/or an operation to be performed on data by the at least one processor 300 of the electronic device 301. A set of the instructions may be referred to as a program, firmware, an operating system, a process, a routine, a sub-routine and/or an application. The memory 310 may include one or more storage media. The memory 310 may include, for example, volatile memory such as random-access memory (RAM) and/or non-volatile memory such as read-only memory (ROM). The volatile memory may include, for example, at least one of dynamic RAM (DRAM), static RAM (SRAM), cache RAM, or pseudo SRAM (PSRAM). The non-volatile memory may include, for example, at least one of programmable ROM (PROM), erasable PROM (EPROM), electrically erasable PROM (EEPROM), flash memory, a hard disk, a compact disk, or an embedded multimedia card (EMMC). As for detailed content of the memory 310 of FIG. 3, the content of the memory 130 of FIG. 1 may be applied substantially the same.

The display 320 may include a hardware component of the electronic device 301 used to display a screen. For example, the display 320 may include light-emitting elements and circuits (e.g., transistors) that control the light-emitting elements to emit light. For example, each of the light emitting elements may include an organic light emitting diode (OLED) or a micro light emitting diode (LED). However, it is not limited thereto. For example, the display 320 may include a liquid crystal display (LCD).

According to an embodiment, the display 320 may include a sensor (e.g., a touch sensor panel (TSP)) for detecting an external object (e.g., a finger of a user) on the display 320. For example, based on the TSP, the electronic device 301 may detect an external object that is contacted with the display 320 or floating on the display 320.

The communication circuitry 330 may include a hardware component for supporting transmission and/or reception of a signal between the electronic device 301 and an external electronic device (e.g., an external electronic device 202 and a server device 203). The communication circuitry 330 may include, for example, at least one of a modem, an antenna, or an optic/electronic (O/E) converter. The communication circuitry 330 may, for example, support transmission and/or reception of an electrical signal based on various types of protocols such as Ethernet, a local area network (LAN), a wide area network (WAN), wireless fidelity (Wi-Fi), Bluetooth, Bluetooth low energy (BLE), Zigbee, long term evolution (LTE), and fifth generation (5G) new radio (NR). For example, the communication circuitry 330 may include first communication circuitry 330-1 and/or second communication circuitry 330-2. For example, the first communication circuitry 330-1 may be communication circuitry for communication according to a protocol of a first type (e.g., BLE), and the second communication circuitry 330-2 may be communication circuitry for communication according to a protocol of a second type (e.g., Wi-Fi, LTE, or 5G NR). However, an embodiment is not limited thereto. As a non-limiting example, the communication circuitry 330 including the first communication circuitry 330-1 and the second communication circuitry 330-2 may be configured with one chip. The number of communication circuitry 330 included in the electronic device 301 is not limited as illustrated in FIG. 3. For example, the electronic device 301 may include third communication circuitry. As for detail content of the communication circuitry 330 of FIG. 3, the communication module 190 of FIG. 1 and/or the antenna module 197 of FIG. 1 may be applied substantially the same.

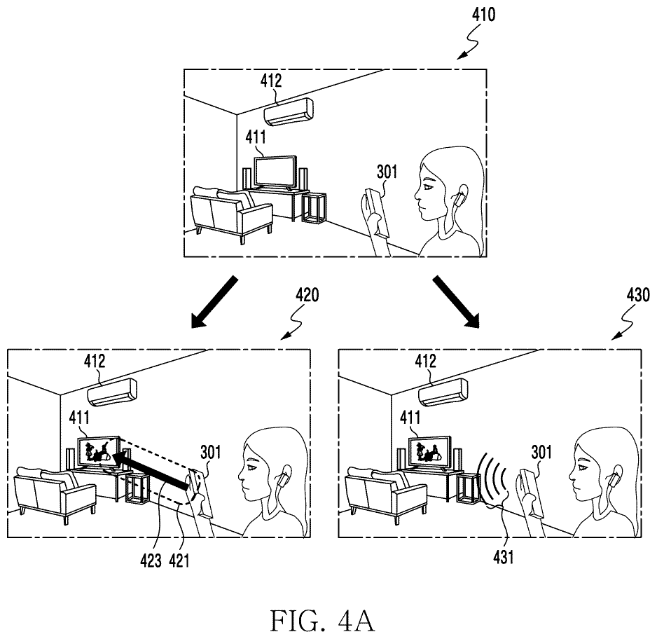

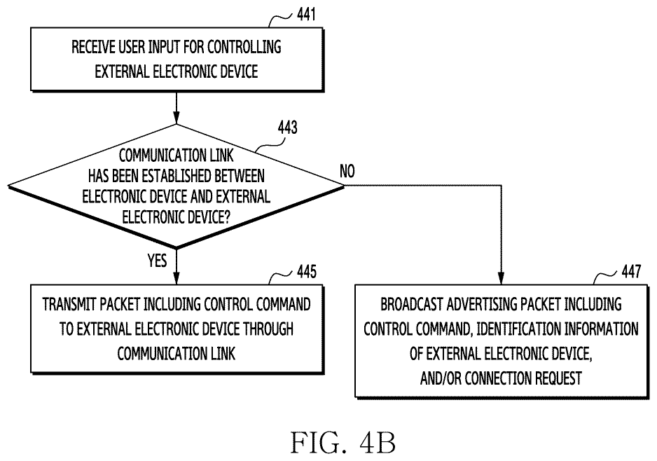

FIG. 4A illustrates an example of an electronic device that adaptively controls an external electronic device according to whether a communication link has been established between the electronic device and the external electronic device according to an embodiment of the disclosure.

Operations of an electronic device 301 exemplified in FIG. 4A may be executed, performed, or controlled by at least one processor (e.g., at least one processor 300). Each of an external electronic device 411 and an external electronic device 412 of FIG. 4A may be an example of the external electronic device 202 of FIG. 2. In FIG. 4A, the external electronic device 411 is illustrated as a television, and the external electronic device 412 is illustrated as an air conditioner, but this is for convenience of explanation and does not limit an embodiment.

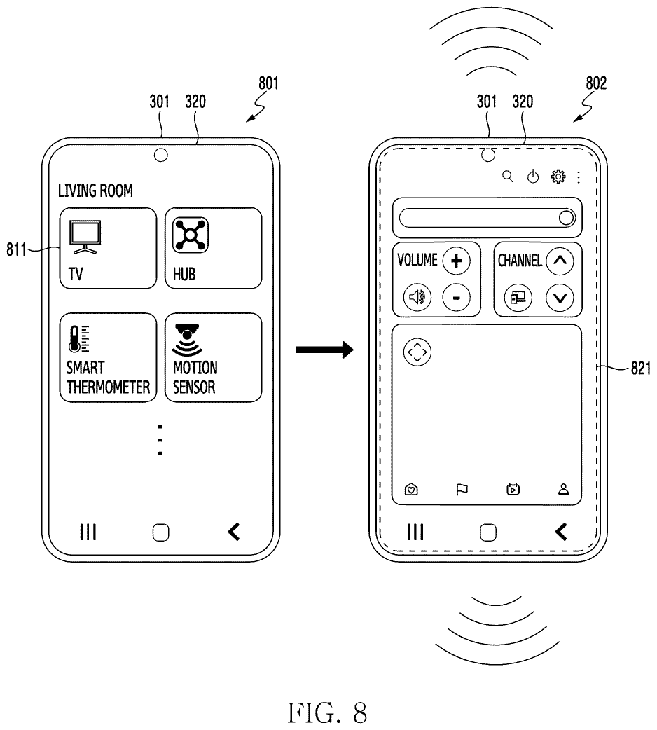

Referring to FIG. 4A, an example 410 may indicate a space including the electronic device 301, the external electronic device 411, and/or the external electronic device 412. The electronic device 301 may be manipulated by a user. The electronic device 301 may receive a user input. For example, the user input may be related to a control application (e.g., an IOT application) in the electronic device 301. For example, the electronic device 301 may receive the user input while executing the control application in a foreground. For example, the electronic device 301 may receive the user input while executing the control application in a background. The control application may provide a function for controlling the external electronic device (e.g., the external electronic device 411, or the external electronic device 412) registered in the electronic device 301. The control application will be described and exemplified in FIG. 8.

According to an embodiment, the electronic device 301 may receive a user input for controlling the external electronic device 411. For example, the external electronic device 411 controlled by the electronic device 301 may be an external electronic device determined according to the user input among one or more external electronic devices registered in the electronic device 301. In an example, the electronic device 301 may identify whether a communication link has been established between the electronic device 301 and the external electronic device 411 based on receiving the user input for controlling the external electronic device 411. For example, based on the electronic device 301 identifying that the communication link has been established between the electronic device 301 and the external electronic device 411, the example 410 may be changed to an example 420. For example, based on the electronic device 301 identifying that the communication link is not established between the electronic device 301 and the external electronic device 411, the example 410 may be changed to an example 430. For example, the electronic device 301 may identify whether the communication link has been established between the electronic device 301 and the external electronic device 411 at a timing at which the user input for controlling the external electronic device 411 is received. Based on the electronic device 301 identifying that the communication link has been established between the electronic device 301 and the external electronic device 411 at the timing at which the user input is received, the example 410 may be changed to the example 420. For example, based on the electronic device 301 identifying that the communication link is not established between the electronic device 301 and the external electronic device 411 at the timing at which the user input is received, the example 410 may be changed to the example 430. For example, the electronic device 301 may identify or determine whether the user input has been received while the communication link has been established or whether the user input has been received while the communication link is not established. For example, as the electronic device 301 receives the user input while the communication link has been established, the example 410 may be changed to the example 420. For example, as the electronic device 301 receives the user input while the communication link is not established, the example 410 may be changed to the example 430.

In the example 420, a method in which the electronic device 301 controls the external electronic device 411 through a communication link 421 established between the electronic device 301 and the external electronic device 411 is illustrated. The electronic device 301 may transmit a packet 423 to the external electronic device 411 using communication circuitry (e.g., first communication circuitry 330-1) through the communication link 421 established between the electronic device 301 and the external electronic device 411. For example, the packet 423 may include a control command for controlling the external electronic device 202. The control command may be generated or obtained according to a user input of the example 410. For example, the control command may cause the external electronic device 202 to provide a function corresponding to the control command. For example, the control command may include a wake-up command, an image display command, an output volume command, and/or a channel change command, but an embodiment is not limited thereto. In an example, the wake-up command may be referred to as a command to change a state of the external electronic device 202 from a standby state to an activation state. For example, the function corresponding to the control command may be determined according to the user input of the example 410. For example, the function corresponding to the control command may include a function of driving the external electronic device 202, a function of causing a wake-up of the external electronic device 202, a function of displaying an image through a display of the external electronic device 202, and/or adjusting a volume (or a size) of audio outputted through a speaker of the external electronic device 202, but the embodiment is not limited thereto. For example, the function of driving the external electronic device 202 may be referred to as a function of changing or switching the state of the external electronic device 202 from an inactivation state to the activation state. The wake-up of the external electronic device 202 may be referred to as a function of changing or switching the state of the external electronic device 202 from the standby state (or a sleep state or a power saving state) to the activation state. For example, the external electronic device 202 may change the state of the external electronic device 202 to a state capable of establishing the communication link 421 by performing the wake-up. As a non-limiting example, the function corresponding to the control command may include a combination of functions corresponding to the exemplified control command.

The external electronic device 411 may receive the packet 423 through the communication link 421. The external electronic device 411 may analyze, decode, inspect, or parse the packet 423. The external electronic device 411 may identify the control command included in the packet 423. The external electronic device 411 may provide the function corresponding to the control command included in the packet 423. For example, the external electronic device 411 may perform wake-up according to the control command included in the packet 423.

In the example 430, a method of controlling the external electronic device 411 by broadcasting an advertising packet 431 is illustrated. The electronic device 301 may broadcast the advertising packet 431 using the communication circuitry (e.g., the first communication circuitry 330-1). For example, the advertising packet 431 may include a control command for controlling the external electronic device 411, identification information of the external electronic device 411, and/or a connection request. The control command for controlling the external electronic device 411 may be generated or obtained according to a user input of the example 410. For example, the control command may cause the external electronic device 411 to provide a function corresponding to the control command. For example, for the function corresponding to the control command, descriptions of the function corresponding to the control command of the example 420 may be referenced. For example, the external electronic device 411 may perform wake-up according to the control command included in the advertising packet 431.

The identification information of the external electronic device 411 included in the advertising packet 431 may be referred to as information used to distinguish the external electronic device 411 from another external electronic device (e.g., the external electronic device 412). For example, the identification information of the external electronic device 411 may be distinguished from identification information of the external electronic device 412. For example, the identification information of the external electronic device 411 may be identified or determined from identification information of each of the external electronic devices (e.g., the external electronic device 411, and the external electronic device 412) registered in the electronic device 301 according to the user input of the example 410. For example, the identification information of the external electronic device 411 may be stored in memory (e.g., memory 310) of the electronic device 301. For example, as the external electronic device 411 is registered in the electronic device 101, the electronic device 301 may obtain or store the identification information of the external electronic device 411. The electronic device 301 may receive an advertising packet broadcasted from the external electronic device 411. For example, the electronic device 301 may obtain the identification information of the external electronic device 411 included in the received advertising packet. The identification information of the external electronic device 411 may include a media access control (MAC) address of the external electronic device 411.

The connection request included in the advertising packet 431 may be referred to as information used to establish a communication link (e.g., the communication link 421) between the electronic device 301 and the external electronic device 411. For example, the external electronic device 411 may start or perform a process for establishing the communication link between the electronic device 301 and the external electronic device 411 based on identifying the connection request included in the advertising packet 431. For example, the connection request may include identification information of the electronic device 301 and/or information indicating whether a connection is possible, but the embodiment is not limited thereto. As a non-limiting example, the connection request may include a connection parameter. For example, the connection parameter may be referred to as a condition for periodically performing a data exchange after the communication link has been established between the electronic device 301 and the external electronic device 411. For example, the connection parameters may include a connection interval, a slave latency, a supervisory timeout, and/or a connection event length, but the embodiment is not limited thereto.

According to an embodiment, the electronic device 301 may periodically broadcast the advertising packet 431. For example, the electronic device 301 may periodically broadcast the advertising packet 431 until the communication link according to the connection request is established. For example, the electronic device 301 may cease, refrain, or bypass periodically broadcasting the advertising packet 431 in response to identifying that the communication link is established according to the connection request.

The external electronic device 411 may receive the advertising packet 431 broadcasted from the electronic device 301. For example, the external electronic device 411 may set a scan duty of a predetermined value to receive the advertising packet 431. For example, the external electronic device 411 may analyze, decode, inspect, or parse the advertising packet 431. For example, the external electronic device 411 may perform verification with respect to identification information included in the advertising packet 431. For example, the external electronic device 411 may identify that the identification information included in the advertising packet 431 is the same as the identification information of the external electronic device 411. For example, the external electronic device 411 may identify the identification information of the external electronic device 411 included in the advertising packet 431. For example, the external electronic device 411 may provide a function corresponding to the control command included in the advertising packet 431 in response to identifying the identification information of the external electronic device 411 included in the advertising packet 431. The external electronic device 411 may start or perform a process for establishing the communication link between the electronic device 301 and the external electronic device 411 in response to identifying the identification information of the external electronic device 411 included in the advertising packet 431.

According to an embodiment, the external electronic device 411 may provide the function corresponding to the control command included in the advertising packet 431 based on receiving the advertising packet 431 a predetermined number of times.

In an embodiment, the advertising packet 431 may cause, allow, or configure the external electronic device 411 to provide the function corresponding to the control command before a communication link (e.g., a communication link 421) is established. For example, after the external electronic device 411 provides the function corresponding to the control command, the external electronic device 411 may start or perform a procedure for establishing the communication link between the electronic device 301 and the external electronic device 411 according to the connection request. As a non-limiting example, while the external electronic device 411 provides the function corresponding to the control command, the external electronic device 411 may start or perform the procedure for establishing the communication link between the electronic device 301 and the external electronic device 411 according to the connection request. For example, after the external electronic device 411 provides the function corresponding to the control command, the communication link according to the connection request may be established between the electronic device 301 and the external electronic device 411.

According to an embodiment, the external electronic device 412 may receive the advertising packet 431 broadcasted from the electronic device 301. For example, the external electronic device 412 may set a scan duty of a predetermined value to receive the advertising packet 431. The external electronic device 412 may analyze, decode, inspect, or parse the advertising packet 431. For example, the external electronic device 412 may identify identification information included in the advertising packet 431. For example, the external electronic device 412 may identify that the identification information included in the advertising packet 431 is different from the identification information of the external electronic device 412. For example, the external electronic device 412 may maintain a state of the external electronic device 412 in response to identifying that the identification information included in the advertising packet 431 and the identification information of the external electronic device 412 are different. For example, an amount of use of a battery resource of the external electronic device 412 may be maintained. For example, the external electronic device 412 may not provide the function corresponding to the control command included in the advertising packet 431. The external electronic device 412 may not be controlled by the advertising packet 431 including the identification information of the external electronic device 411.

According to an embodiment, after the electronic device 301 broadcasts the advertising packet 431, the electronic device 301 may receive another user input for controlling the external electronic device 411. In an example, for convenience of explanation, the user input of the example 410 may be assumed to be a first user input. For example, after the electronic device 301 broadcasts the advertising packet 431, the other user input received by the electronic device 301 may be assumed to be a second user input. A function corresponding to the first user input and a function corresponding to the second user input may be different. For example, the function corresponding to the first user input may be a function that causes a wake-up of the external electronic device 411, and the function corresponding to the second user input may be a function of increasing a volume of audio outputted by the external electronic device 411. As a non-limiting example, the function corresponding to the first user input and the function corresponding to the second user input may be substantially the same. Each of the function corresponding to the first user input and the function corresponding to the second user input may be the function that causes the wake-up of the external electronic device 411.

Based on receiving the second user input, the electronic device 301 may identify whether the communication link has been established between the electronic device 301 and the external electronic device 411. For example, the electronic device 301 may identify whether the communication link has been established according to the connection request included in the advertising packet 431. For example, based on identifying that the communication link has been established according to the connection request, the electronic device 301 may transmit a control command according to the second user input, through the established communication link to the external electronic device 411, using the communication circuitry (e.g., the first communication circuitry 330-1). The electronic device 301 may broadcast an advertising packet using the communication circuitry (e.g., first communication circuitry 330-1) based on identifying that the communication link according to the connection request is not established. For example, the advertising packet may include the control command according to the second user input and/or the identification information of the external electronic device 411. As a non-limiting example, the advertising packet may not include the connection request for establishing the communication link between the electronic device 301 and the external electronic device 411. As a non-limiting example, the advertising packet may include the control command according to the second user input, the identification information of the external electronic device 411, and/or the connection request.

In an embodiment, the electronic device 301 may identify or determine whether the second user input has been received while the communication link according to the connection request included in the advertising packet 431 has been established or whether the second user input has been received while the communication link according to the connection request included in the advertising packet 431 is not established. For example, the electronic device 301 may transmit the control command according to the second user input to the external electronic device 411, through the established communication link to the external electronic device 411, using the communication circuitry (e.g., the first communication circuitry 330-1), based on the second user input received while the communication link according to the connection request has been established. For example, the electronic device 301 may broadcast an advertising packet using the communication circuitry (e.g., the first communication circuitry 330-1) based on the second user input received while the communication link according to the connection request is not established. The advertising packet may include the control command according to the second user input and/or the identification information of the external electronic device 411. As a non-limiting example, the advertising packet may not include the connection request for establishing the communication link between the electronic device 301 and the external electronic device 411. As a non-limiting example, the advertising packet may include the control command according to the second user input, the identification information of the external electronic device 411, and/or the connection request.

FIG. 4B illustrates an example of operations of an electronic device that adaptively controls an external electronic device according to whether a communication link has been established between the electronic device and the external electronic device according to an embodiment of the disclosure.

Operations of the electronic device (e.g., an electronic device 301) exemplified in FIG. 4B may be executed, performed, or controlled by at least one processor (e.g., at least one processor 300).

Referring to FIG. 4B, in operation 441, the electronic device 301 may receive a user input for controlling the external electronic device (e.g., an external electronic device 202, an external electronic device 411, or an external electronic device 412). For example, the external electronic device may be registered in the electronic device 301. For example, the external electronic device may be registered in a server device (e.g., a server device 203) as associated with the electronic device 301.

According to an embodiment, the user input for controlling the external electronic device may be received while a control application for controlling the external electronic device is being executed. For example, the control application may be referred to as an IOT application. In an example, the control application may be executed in a foreground of the electronic device 301 and/or in a background of the electronic device 301.

In operation 443, the electronic device 301 may identify whether the communication link (e.g., a communication link 421) has been established between the electronic device 301 and the external electronic device (e.g., the external electronic device 202, the external electronic device 411, or the external electronic device 412). For example, the electronic device 301 may identify whether the communication link has been established between the electronic device 301 and the external electronic device at a timing at which a user input is received. For example, the electronic device 301 may identify whether a user input has been received while the communication link has been established or whether a user input has been received while the communication link is not established.

According to an embodiment, the electronic device 301 may execute operation 445 based on identifying that the communication link has been established between the electronic device and the external electronic device. For example, the electronic device 301 may execute the operation 445 based on identifying that the communication link has been established between the electronic device 301 and the external electronic device at the timing at which the user input is received. For example, the electronic device 301 may execute the operation 445 based on the user input received while the communication link has been established.

According to an embodiment, the electronic device 301 may execute operation 447 based on identifying that the communication link is not established between the electronic device and the external electronic device. For example, the electronic device 301 may execute the operation 447 based on identifying that the communication link is not established between the electronic device 301 and the external electronic device at the timing when the user input is received. For example, the electronic device 301 may execute the operation 447 based on the user input received while the communication link is not established.

In operation 445, the electronic device 301 may transmit a packet (e.g., a packet 423), including a control command through the established communication link to the external electronic device (e.g., the external electronic device 202, the external electronic device 411, or the external electronic device 412), using communication circuitry (e.g., second communication circuitry 330-2). For example, the control command may be generated according to a user input. The control command may cause the external electronic device to provide a function corresponding to the control command. For example, the operation 445 may correspond to the example 420 of FIG. 4A. For the operation 445, descriptions of the example 420 of FIG. 4A may be referenced.

In operation 447, the electronic device 301 may broadcast an advertising packet including a control command, identification information of the external electronic device (e.g., the external electronic device 202, the external electronic device 411, or the external electronic device 412), and/or a connection request using communication circuitry (e.g., first communication circuitry 330-1). For example, the control command may be generated according to a user input. For example, the identification information of the external electronic device may be referred to as information used to distinguish the external electronic device from another external electronic device. For example, the identification information of the external electronic device may include a media access control (MAC) address of the external electronic device. For example, the connection request may be referred to as information used to establish the communication link (e.g., the communication link 421) between the electronic device 301 and the external electronic device. For example, the advertising packet may cause the external electronic device to provide a function corresponding to the control command before the communication link is established. For example, upon receiving the advertising packet, the external electronic device may provide the function corresponding to the control command. For example, after the external electronic device provides the function corresponding to the control command, a procedure for establishing the communication link between the electronic device 301 and the external electronic device may be started or performed. As a non-limiting example, while the external electronic device provides the function corresponding to the control command, a process for establishing the communication link between the electronic device 301 and the external electronic device may be started or performed. In an example, after the external electronic device provides the function corresponding to the control command, the communication link may be established between the electronic device 301 and the external electronic device. The operation 447 may correspond to the example 430 of FIG. 4A. For the operation 447, descriptions of the example 430 of FIG. 4A may be referenced.

As a non-limiting example, based on identifying that the communication is not established between the electronic device 301 and the external electronic device (e.g., the external electronic device 202, the external electronic device 411, or the external electronic device 412), the electronic device 310 may identify whether the communication link is capable of being established between the electronic device 301 and the external electronic device according to a system resource of the electronic device 301. For example, the electronic device 301 may broadcast the advertising packet including the control command, the identification information of the external electronic device, and the connection request using the communication circuitry according to the system resource of the electronic device 301 capable of establishing the communication link. The advertising packet may cause the external electronic device to provide the function corresponding to the control command before the communication link is established according to the connection request. For example, the electronic device 301 may broadcast an advertising packet including the control command and the identification information of the external electronic device from among the control command, the identification information of the external electronic device, and the connection request, using the communication circuitry, according to a system resource of the electronic device 301, which is not capable of establishing the communication link. For example, the advertising packet may not include the connection request. For example, the system resource may include the communication circuitry, an amount of use of the at least one processor, and/or an amount of use of memory, but the embodiment is not limited thereto.

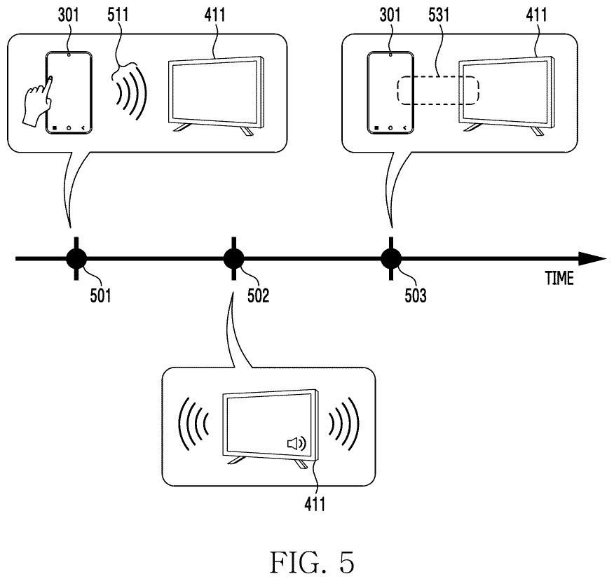

FIG. 5 illustrates an example in which a communication link is established between an electronic device and an external electronic device after the external electronic device provides a function corresponding to a control command according to an embodiment of the disclosure.

Operations of an electronic device 301 exemplified in FIG. 5 may be executed, performed, or controlled by at least one processor (e.g., at least one processor 300).

Referring to FIG. 5, at a timing 501, the electronic device 301 may receive a user input. For example, the user input may represent an input for controlling an external electronic device 411. In FIG. 5, the user input is illustrated as a touch input using a display (e.g., a display 320) of the electronic device 301, but an embodiment is not limited thereto. As a non-limiting example, the user input may include a touch input, an input using a voice command, an input using an input device (e.g., a stylus), and/or an input using an external electronic device (e.g., a wearable device connected to the electronic device 301).

The electronic device 301 may broadcast an advertising packet 511 based on receiving the user input. For example, for an operation of the electronic device 301 broadcasting the advertising packet 511, descriptions of the example 430 of FIG. 4A may be referenced. The advertising packet 511 may be an example of the advertising packet 431 of FIG. 4A. The advertising packet 511 may include a control command for controlling the external electronic device 411, identification information of the external electronic device 411, and/or a connection request.

The external electronic device 411 may receive the advertising packet 511 using communication circuitry of the external electronic device 411. The external electronic device 411 may analyze, decode, inspect, or parse the advertising packet 511 in response to receiving the advertising packet 511. For example, the external electronic device 411 may identify the control command and/or the connection request.

At a timing 502, the external electronic device 411 may execute a function corresponding to a control command included in the advertising packet 511. For example, the external electronic device 411 may be controlled by the electronic device 301. For example, the external electronic device 411 may provide the function corresponding to the control command. The external electronic device 411 may perform a wake-up. For example, a state of the external electronic device 411 may be changed from a standby state (or an inactivation state) to an active state. For example, the external electronic device 411 may display a screen through a display of the external electronic device 411. For example, the external electronic device 411 may output audio through a speaker of the external electronic device 411.

In an embodiment, the external electronic device 411 may execute or perform a process according to the connection request while providing the function corresponding to the control command. For example, the process according to the connection request may be referred to as a process for establishing a communication link 531 between the electronic device 301 and the external electronic device 411. As a non-limiting example, the external electronic device 411 may execute the process according to the connection request after providing the function corresponding to the control command. For example, the external electronic device 411 may transmit a signal for establishing the communication link 531 to the electronic device 301. For example, the electronic device 301 may receive the signal for establishing the communication link 531 from the external electronic device 411 through communication circuitry (e.g., first communication circuitry 330-1). For example, the electronic device 301 may perform or execute the process for establishing the communication link 531.

At a timing 503, the communication link 531 may be established between the electronic device 301 and the external electronic device 411. For example, the communication link 531 may be an example of the communication link 421 of FIG. 4A. For example, descriptions of the communication link 421 may be referenced for the communication link 531. After the communication link 531 is established, the electronic device 301 may transmit a signal to the external electronic device 411 through the communication link 531 using the communication circuitry (e.g., the first communication circuitry 330-1).

According to an embodiment, after the external electronic device 411 provides the function corresponding to the control command at the timing 502, the communication link 531 may be established at the timing 503. For example, since the timing 501, the timing 502 may arrive before the timing 503. For example, a time difference between the timing 501 and the timing 502 may be shorter than a time difference between the timing 501 and the timing 503. For example, after the electronic device 301 receives the user input for controlling the external electronic device 411 at the timing 501, the timing 502 at which the external electronic device 411 is controlled may arrive faster than the timing 503 at which the communication link 531 is established. For example, since the timing 502 at which the external electronic device 411 is controlled is faster than the timing 503 at which the communication link 531 is established, the external electronic device 411 may be controlled relatively quickly by the electronic device 301. For example, since the external electronic device 411 is controlled relatively quickly by the electronic device 301, the electronic device 301 may provide or cause convenience to a user. For example, since the timing 502 at which the external electronic device 411 is controlled is faster than the timing 503 at which the communication link 531 is established, the electronic device 301 may provide a relatively small latency. The latency may be referred to as a time interval from the timing 501 at which the user input is received to the timing 502 at which the external electronic device 411 is controlled. For example, a latency in a case in which the communication link 531 is established after the external electronic device 411 is controlled may be shorter than a latency in a case that the communication link 531 is established before the external electronic device 411 is controlled. For example, since the electronic device 301 provides the relatively small latency, the electronic device 301 may provide or cause convenience to the user. For example, as the latency provided by the electronic device 301 is shorter, the electronic device 301 may provide bigger convenience to the user. For example, user experience of the electronic device 301 may be enhanced.

According to an embodiment, the electronic device 301 may receive another user input for controlling the external electronic device 411 after the communication link 531 is established. The electronic device 301 may generate, obtain, or identify a control command according to the other user input. For example, the electronic device 301 may transmit the control command to the external electronic device 411 using the communication circuitry (e.g., the first communication circuitry 330-1) through the communication link 531. For example, after the communication link 531 is established, the electronic device 301 may control the external electronic device 411 through the communication link 531. By controlling the external electronic device 411 through the communication link 531 after the communication link 531 is established, stability in data communication between the electronic device 301 and the external electronic device 411 may be enhanced.

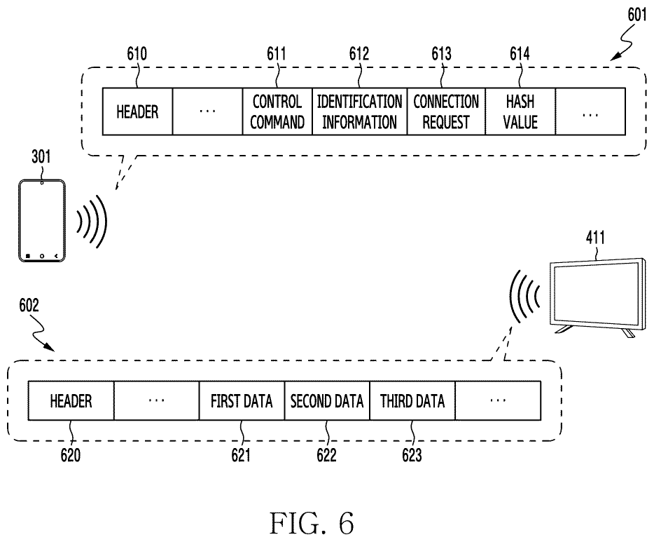

FIG. 6 illustrates an example of an advertising packet broadcasted by each of an electronic device and an external electronic device according to an embodiment of the disclosure.

Operations of an electronic device 301 exemplified in FIG. 6 may be executed, performed, or controlled by at least one processor (e.g., at least one processor 300).

Referring to FIG. 6, the electronic device 301 may broadcast an advertising packet 601. The electronic device 301 may broadcast the advertising packet 601 using communication circuitry (e.g., communication circuitry 330). For example, the advertising packet 601 may be broadcast by the communication circuitry using various communication protocols. For example, various communication protocols may include Bluetooth low energy (BLE), Bluetooth, Zigbee, Z-wave, Wi-Fi direct, Thread, near field communication (NFC), and/or infrared communication, but an embodiment is not limited thereto. For example, the advertising packet 601 may be an example of the advertising packet 431 of FIG. 4A and/or the advertising packet 511 of FIG. 5. For the advertising packet 601, descriptions of the advertising packet 431 and/or descriptions of the advertising packet 511 may be referenced. The advertising packet 601 may include a header 610, a control command 611, identification information 612, a connection request 613, and/or a hash value 614. However, the embodiment is not limited thereto. For example, the advertising packet 601 may further include other data.

The header 610 may be used to identify a format (or a standard) defined in the advertising packet 601. For example, the header 610 may include data indicating a format of the advertising packet 601. The header 610 may include identification information of a communication protocol, version information of the communication protocol, version information of a software of the electronic device 301, command code information, and/or a security token. The identification information of the communication protocol may indicate a communication protocol used to broadcast the advertising packet 601. For example, the identification information of the communication protocol may be referred to as a protocol identifier. For example, the version information of the communication protocol may indicate a version of the communication protocol used to broadcast the advertising packet 601.

The version information of the software of the electronic device 301 may indicate a version of an operating system executed in the electronic device 301 and/or a version of firmware executed in the electronic device 301. The command code information may indicate an operation to be performed in an external electronic device 411 receiving the advertising packet 601. In an example, the operation to be performed in the external electronic device 411 receiving the advertising packet 601 may include an operation in which the external electronic device 411 identifies whether an external electronic device indicated by the identification information 612 corresponds to the external electronic device 411, an operation in which the external electronic device 411 verifies reliability of the control command 611 using the security token, an operation in which the external electronic device 411 provides a function corresponding to the control command 611, and/or an operation in which the external electronic device 411 starts or performs a process for establishing a communication link according to the connection request 613, but the embodiment is not limited thereto. For example, the operation to be performed in the external electronic device 411 receiving the advertising packet 601 may further include operations exemplified as being performed in the external electronic device 411 receiving the advertising packet 431 in the example 430 of FIG. 4A.

The security token may be used to verify the reliability of the advertising packet 601. As a non-limiting example, the header 610 may further include data indicating a manufacturer of the electronic device 301 and/or data indicating a type (e.g., a product group) of the electronic device 301.

The control command 611 may be obtained or generated according to a user input for controlling an external electronic device (e.g., the external electronic device 411). For example, the control command 611 may cause the external electronic device 411 to provide a function corresponding to the control command 611. For example, for the control command 611, descriptions of the control command of FIG. 4A may be referenced. As a non-limiting example, a capacity of the control command 611 may be 1 byte.

The identification information 612 may indicate the external electronic device 411 controlled by the electronic device 301. For example, the identification information 612 may be identification information of the external electronic device 411. For example, for the identification information 612, descriptions of the identification information of the external electronic device 411 of FIG. 4A may be referenced. As a non-limiting example, a capacity of the identification information 612 may be 6 bytes.

The connection request 613 may be referred to as information used to establish a communication link (e.g., a communication link 421) between the electronic device 301 and the external electronic device 411. For example, for the connection request 613, descriptions of the connection request of FIG. 4A may be referenced.

The hash value 614 may be used to enhance security of the advertising packet 601. For example, the hash value 614 may be generated by applying a hash function to the control command 611, the identification information 612, and/or the connection request 613. The hash value 614 may be used to verify integrity with respect to the control command 611, the identification information 612, and/or the connection request 613. For example, after receiving the advertising packet 601, the external electronic device 411 may compare the generated verification data by applying the hash function to the hash value 614 and the control command 611, the identification information 612, and/or the connection request 613. For example, the integrity with respect to the control command 611, the identification information 612, and/or the connection request 613 may be verified based on the hash value 614 corresponding to the verification data. For example, the external electronic device 411 may determine that the control command 611, the identification information 612, and/or the connection request 613 are not damaged (or changed or forged).

The external electronic device 411 may broadcast an advertising packet 602. The advertising packet 602 may include a header 620, first data 621, second data 622, and/or third data 623. Since the header 620 may be substantially the same as the header 610, redundant description will be omitted for convenience of explanation.

The first data 621 may indicate whether the external electronic device 411 supports a function of performing operations according to the command code information in the header 610 in response to receiving the advertising packet 601 broadcasted from the electronic device 301. As a non-limiting example, what indicates that the first data 621 supports the function of performing the operations according to the command code information in the header 610 may be referred to as the external electronic device 411 being configured to provide the function corresponding to the control command 611 included in the advertising packet 601.

The second data 622 may indicate whether the external electronic device 411 is in a state of being capable of performing the function corresponding to the control command included in the advertising packet 601 based on receiving the advertising packet 601. As a non-limiting example, what indicates that the second data 622 is in a state of not being capable of performing the function corresponding to the control command included in the advertising packet 601 may be referred to as an amount of a resource of the external electronic device 411 being less than a reference amount for performing the function corresponding to the control command.

The third data 623 may indicate whether the external electronic device 411 may establish a communication link. The third data 623 may indicate whether an amount of a resource related to the communication link of the external electronic device 411 is greater or less than a reference amount for establishing the communication link.

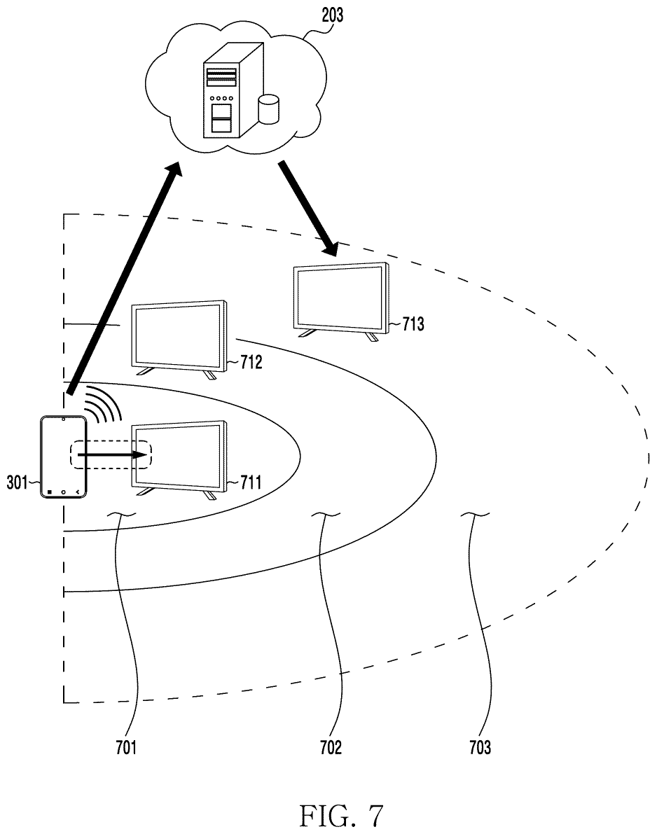

FIG. 7 illustrates an example of an electronic device that adaptively controls an external electronic device according to a distance between the electronic device and the external electronic device according to an embodiment of the disclosure.

Operations of the electronic device (e.g., an electronic device 301) exemplified in FIG. 7 may be executed, performed, or controlled by at least one processor (e.g., at least one processor 300). Each of external electronic devices 711, 712, and 713 may be an example of an external electronic device 202. For example, each of the external electronic devices 711, 712, and 713 may be an example of an external electronic device 411.

Referring to FIG. 7, the electronic device 301 may search for the external electronic devices 711, 712, and 713. For example, the electronic device 301 may perform a scan on an advertising packet (e.g., an advertising packets 602) broadcasted from the external electronic devices 711, 712, and 713. For example, the electronic device 301 may set a scan duty to a first value (e.g., 100%) while executing a control application in a foreground. For example, the electronic device 301 may set the scan duty to a second value smaller than the first value while executing the control application in a background.

An area 701 may be closer to the electronic device 301 than an area 702. The external electronic device 711 may be positioned in the area 701. According to an embodiment, a communication link (e.g., a communication link 421 or 531) may be established between the electronic device 301 and the external electronic device 711. The electronic device 301 may control the external electronic device 711 through the established communication link.

According to an embodiment, there may be an establishment policy of the electronic device 301 for establishing the communication link. For example, the establishment policy may include a condition in which the control application is executed in the foreground of the electronic device 301. For example, the establishment policy may include a condition for receiving an advertising packet (e.g., an advertising packet 602) in which data (e.g., first data 621) indicating support for the function of performing the operations according to the command code information is included, from an external electronic device 711. For example, the establishment policy may include a condition in which reception intensity of a signal including the advertising packet (e.g., the advertising packet 602) broadcasted from the external electronic device 711 exceeds reference intensity. The establishment policy may include a condition in which a communication link is not established between a predetermined external electronic device and the electronic device 301. For example, the establishment policy may include a condition in which the number of communication links established by the electronic device 301 is less than a maximum number of connections. For example, the establishment policy may include a condition in which the external electronic device 711 is registered in the electronic device 301. For example, the establishment policy may include a condition in which a release process of the communication link is not being performed.

According to an embodiment, there may be a release policy of the electronic device 301 for releasing the communication link. For example, the release policy may include a condition in which the control application is executed in the background of the electronic device 301 for a predetermined time (e.g., 10 seconds). For example, the release policy may include a condition in which a distance between the electronic device 301 and the external electronic device 711 exceeds a reference distance. As an example, the release policy may include a condition in which a release process of the communication link is performed in the external electronic device 711.

As a non-limiting example, there may be further conditions related to the establishment of the communication link and/or the release of the communication link. For example, the electronic device 301 may identify a fastest request within a defined time in response to identifying requests for the establishment of the communication link within the defined time. For example, the electronic device 301 may bypass remaining requests except for the fastest request within the defined time in response to identifying the requests for the establishment of the communication link within the defined time. For example, the electronic device 301 may identify a fastest request within the defined time in response to identifying requests for the release of the communication link within the defined time. For example, the electronic device 301 may bypass remaining requests except for the fastest request within the defined time in response to identifying the requests for the release of the communication link within the defined time.

For example, the electronic device 301 may cease, refrain, skip, or bypass the establishment of the communication link in response to identifying an input for the release of the communication link while establishing the communication link. For example, the electronic device 301 may cease, refrain, skip, or bypass the release of the communication link in response to identifying an input for the establishment of the communication link while releasing the communication link. In an example, the electronic device 301 may start or perform a process for the establishment of the communication link in response to identifying the input for the establishment of the communication link while the control application is executed in the foreground. For example, the electronic device 301 may identify whether a first predetermined time (e.g., 30 seconds) has elapsed since the process for the establishment of the communication link starts. For example, the electronic device 301 may cease, skip, terminate, refrain, or bypass the process for the establishment of the communication link based on identifying that the communication link is not established after the first predetermined time has elapsed. For example, the first predetermined time may be referred to as a timeout.

For example, the electronic device 301 may start or perform the process for the release of the communication link in response to identifying the input for the release of the communication link while the control application is executed in the foreground. For example, the electronic device 301 may identify whether a second predetermined time (e.g., 10 seconds) has elapsed since receiving the input for the release of the communication link while the control application is executed in the foreground. For example, the electronic device 301 may start or perform the process for the release of the communication link after the second predetermined time has elapsed. For example, the second predetermined time may be referred to as a guard time.

The electronic device 301 may ignore the input in response to identifying the input for the establishment of the communication link while the control application is executed in the background. For example, the electronic device 301 may refrain, skip, or bypass performing the process for the establishment of the communication link corresponding to the input in response to identifying the input for the establishment of the communication link while the control application is executed in the background. For example, the electronic device 301 may refrain, skip, or bypass performing the process of the release of the communication link corresponding to the input in response to identifying the input for the release of the communication link while the control application is executed in the background.

The area 702 may be closer to the electronic device 301 than an area 703. The area 702 may be positioned farther from the electronic device 301 than the area 701. The external electronic device 712 may be positioned in the area 702. The electronic device 301 may identify reception intensity of a signal broadcasted from the external electronic device 712 in the area 702 lower than the reception intensity of the signal (e.g., including the advertising packet 602) broadcasted from the external electronic device 711 in the area 701. For example, the reception intensity of the signal broadcasted from the external electronic device 711 may be higher than the reference intensity. The reception intensity of the signal broadcasted from the external electronic device 712 may be lower than the reference intensity. The reference intensity may be referred to as reception intensity of a signal indicating that a control quality according to a method in which the electronic device 301 controls an external electronic device through a communication link corresponds to a control quality according to a method in which the electronic device 301 controls the external electronic device by broadcasting an advertising packet.

According to an embodiment, since the reception intensity of the signal broadcasted from the external electronic device 711 is higher than the reference intensity, the electronic device 301 may determine to control the external electronic device 711 through the communication link. For example, the communication link may be established as the electronic device 301 broadcasts an advertising packet (e.g., an advertising packet 431, 511, or 601) that includes a connection request (e.g., a connection request 613). For example, based on the connection request, the communication link may be established between the electronic device 301 and the external electronic device 711.

In an embodiment, since the reception intensity of the signal broadcasted from the external electronic device 712 is lower than the reference intensity, the electronic device 301 may control the external electronic device 712 by broadcasting the advertising packet (e.g., the advertising packet 431, 511, or 601). For example, the electronic device 301 may broadcast an advertising packet that does not include the connection request (e.g., the connection request 613). For example, the advertising packet may include a control command and identification information of the external electronic device 712 from among the control command (e.g., a control command 611), the identification information (e.g., identification information 612) of the external electronic device 712, the connection request (e.g., the connection request 613). For example, in a case that a communication link between the electronic device 301 and the external electronic device 712 is established, stability of the communication link may be relatively low. Since the reception intensity of the signal from broadcasted the external electronic device 712 is lower than the reference intensity, the communication link between the electronic device 301 and the external electronic device 712 may be frequently released (or disconnected).

The area 703 may be positioned farther from the electronic device 301 than the area 702. The external electronic device 713 may be positioned in the area 703. The electronic device 301 may not receive a signal (e.g., including the advertising packet 602) broadcasted from the external electronic device 713 in the area 703. For example, since a distance between the electronic device 301 and the external electronic device 713 is far, the signal broadcasted from the external electronic device 713 may not be received from the electronic device 301. For example, the signal broadcasted from the external electronic device 713 may not be received by the electronic device 301 within a defined time interval. As an example, the defined time interval may indicate a time interval at which the electronic device 301 may receive a signal broadcasted from an external electronic device.

According to an embodiment, the electronic device 301 may receive the signal (e.g., including the advertising packet 602) broadcasted from the external electronic device 713 in the area 703. For example, since the distance between the electronic device 301 and the external electronic device 713 is far, reception intensity of the signal broadcasted from the external electronic device 713 may be relatively small. For example, in a case that the reception intensity of the signal is a received signal strength indicator (RSSI), the reception intensity of the signal broadcasted from the external electronic device 713 may be less than −75.

According to an embodiment, the electronic device 301 may transmit, using communication circuitry (e.g., second communication circuitry 330-2), a control command such that the control command is delivered to the external electronic device 713. For example, the electronic device 301 may transmit, to a server device 203, a request for transmitting the control command to the external electronic device 713 through the server device 203. For example, the electronic device 301 may transmit the control command to the server device 203. For example, the server device 203 may transmit the control command transmitted from the electronic device 301 to the external electronic device 713.

FIG. 8 illustrates an example of an electronic device that executes an application for controlling an external electronic device according to an embodiment of the disclosure.

Operations of an electronic device 301 exemplified in FIG. 8 may be executed, performed, or controlled by at least one processor (e.g., at least one processor 300).

Referring to FIG. 8, an example 801 may indicate a state in which the electronic device 301 executes a control application. For example, the control application may be referred to as an application for controlling an external electronic device (e.g., an external electronic device 202, an external electronic device 411, or an external electronic device 412). For example, the control application may be related to provision of an IOT service. For example, the control application may be referred to as an IOT application.

The electronic device 301 may display a user interface (UI) of the control application through a display 320. For example, the UI may be displayed while executing the control application. For example, the UI may be displayed while the control application is executed in a foreground of the electronic device 301. For example, the electronic device 301 may display at least one visual object corresponding to at least one external electronic device registered in the electronic device 301, in the UI. For example, each of the at least one visual object may be referred to as a device card. For example, the electronic device 301 may determine an external electronic device for control through a user input to a visual object among the at least one visual object. For example, the electronic device 301 may display a visual object 811 in the UI. For example, the visual object 811 may correspond to an external electronic device (e.g., the external electronic device 411). For example, the electronic device 301 may receive a user input to the visual object 811. According to the reception of the user input to the visual object 811, the electronic device 301 may determine to control the external electronic device (e.g., the external electronic device 411). For example, the user input to the visual object 811 may be a user input for controlling the external electronic device (e.g., the external electronic device 411). For example, the user input to the visual object 811 may be an example of the user input of the example 410 of FIG. 4A. For example, the electronic device 301 may execute the operation 443 of FIG. 4B based on the user input to the visual object 811. For example, the electronic device 301 may execute the operation 443 of FIG. 4B and then execute the operation 447 of FIG. 4B. For example, the electronic device 301 may display an execution screen 821 for controlling the external electronic device 411 through the display 320 based on the user input to the visual object 811.

In an example 802, the electronic device 301 may broadcast an advertising packet (e.g., an advertising packet 431, 511, or 601) including a control command (e.g., a control command 611), identification information (e.g., identification information 612) of the external electronic device 411, and/or a connection request (e.g., a connection request 613) based on the user input to the visual object 811. For example, after broadcasting the advertising packet, the electronic device 301 may establish a communication link (e.g., a communication link 421 or 531) between the electronic device 301 and the external electronic device (e.g., the external electronic device 411) according to the connection request 613.

The electronic device 301 may, for example, display the execution screen 821 for controlling the external electronic device (e.g., the external electronic device 411) through the display 320 according to the user input to the visual object 811. For example, the execution screen 821 may be referred to as a screen for a remote control function of the electronic device 301. For example, visual objects included in the execution screen 821 may be determined or edited by a user. For example, the execution screen 821 may include a visual object to adjust a size of audio outputted through a speaker of the external electronic device, a visual object to change an image (or a video) displayed through the display of the external electronic device, a visual object to select icons displayed through the display of the external electronic device, and/or a visual object to change a state of the external electronic device from an activation state to an inactivation state (or a sleep state), but an embodiment is not limited thereto. For example, the execution screen 821 may be referred to as a plug-in screen. For example, according to a user input to each of the visual objects included in the execution screen 821, the electronic device 301 may generate or obtain a control command (e.g., the control command 611) corresponding to a corresponding visual object. The electronic device 301 may transmit the control command corresponding to the corresponding visual object to the external electronic device (e.g., the external electronic device 411) using communication circuitry (e.g., first communication circuitry 330-1). For example, the electronic device 301 may transmit the control command corresponding to the corresponding visual object to the external electronic device (e.g., the external electronic device 411) through the established communication link using the communication circuitry (e.g., the first communication circuitry 330-1).

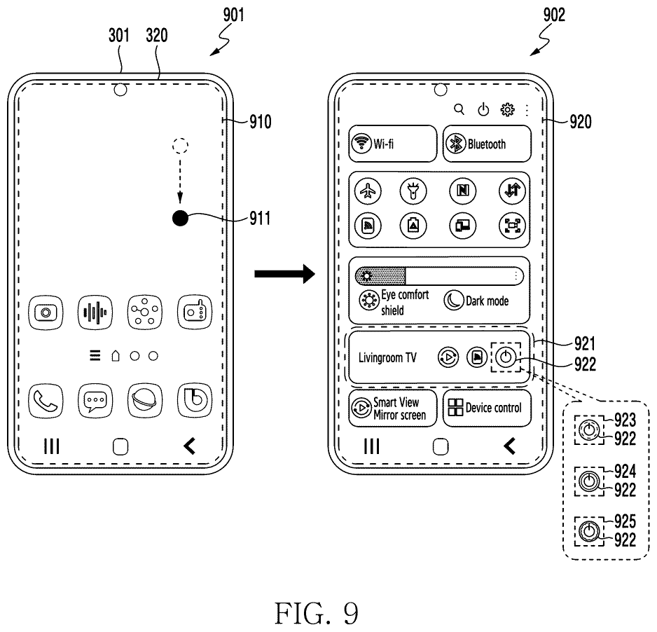

FIG. 9 illustrates an example of a visual object for controlling an external electronic device according to an embodiment of the disclosure.

Referring to FIG. 9, in an example 901, an electronic device 301 may display a home screen 910 through a display 320. For example, while the electronic device 301 displays the home screen 910, a control application may be executed in a background of the electronic device 301. For example, while displaying the home screen 910, the electronic device 301 may receive a user input 911. For example, the user input 911 may include a swipe input facing downward from an upper area of the home screen 910, but an embodiment is not limited thereto. For example, the user input 911 may include a drag input facing downward from a periphery of the display 320. For example, the user input 911 may be referred to as an input for displaying a quick panel screen 920. As an example, the quick panel screen 920 may be referred to as a screen including a visual object for setting a function of the electronic device 301 and/or a visual object displaying a state of the electronic device 301. For example, each of visual objects included in the quick panel screen 920 may be related to adjusting brightness of the display 320, setting a size of audio outputted by the electronic device 301, setting a power saving mode of the electronic device 301, and/or control of an external electronic device (e.g., an external electronic device 202, an external electronic device 411, or an external electronic device 412), but the embodiment is not limited thereto.

In an example 902, the electronic device 301 may display the quick panel screen 920 through the display 320. For example, the quick panel screen 920 may include a visual object 921. For example, the visual object 921 may provide a function for control of an external electronic device. In an example, the visual object 921 may include a visual object 922. For example, in response to a user input to the visual object 922, the electronic device 301 may control the external electronic device such that the external electronic device performs a wake-up.

The visual object 922 may represent another visual effect according to a method in which the electronic device 301 controls the external electronic device. By displaying the visual object 922 representing the other visual effect according to the method in which the electronic device 301 controls the external electronic device, the electronic device 301 may intuitively display the method of controlling the external electronic device. For example, user experience of the electronic device 301 may be enhanced.

According to an embodiment, in a case that the electronic device 301 controls the external electronic device by broadcasting an advertising packet (e.g., an advertising packet 431, 511, or 601) including a control command (e.g., a control command 611), the visual object 922 may represent a visual effect 923. For example, the electronic device 301 may display the visual object 922 representing the visual effect 923 in the visual object 921. The visual effect 923 may indicate that a communication link (e.g., a communication link 421, or 531) is not established between the electronic device 301 and the external electronic device. As an embodiment, the visual effect 923 may include a dotted line being represented at a periphery of the visual object 922. As a non-limiting example, the visual effect 923 may represent a first color.

According to an embodiment, while the visual object 922 displays the visual effect 923, the communication link may not be established between the electronic device 301 and the external electronic device.

According to an embodiment, in a case that the electronic device 301 controls the external electronic device by transmitting a packet (e.g., a packet 423) including the control command (e.g., the control command 611) to the external electronic device through the communication link (e.g., the communication link 421 or 531), the visual object 922 may represent a visual effect 924. For example, the electronic device 301 may display the visual object 922 representing the visual effect 924 in the visual object 921. For example, the visual effect 924 may indicate that the communication link is established between the electronic device 301 and the external electronic device. For example, the visual effect 924 may be distinguished from the visual effect 923. In an embodiment, the visual effect 923 may include a solid line being represented at the periphery of the visual object 922. As a non-limiting example, the visual effect 924 may represent a second color different from the first color.

In an embodiment, in a case that the electronic device 301 controls the external electronic device by transmitting the control command 611 such that the control command (e.g., the control command 611) is delivered to the external electronic device, the visual object 922 may represent a visual effect 925. For example, the electronic device 301 may display the visual object 922 representing the visual effect 925 in the visual object 921. For example, the visual effect 925 may indicate that the electronic device 301 may control the external electronic device using a relay device. For example, the visual effect 925 may be distinguished from the visual effect 923. For example, the visual effect 925 may be distinguished from the visual effect 924. In an embodiment, the visual effect 925 may include a solid cloud-shaped line represented at the periphery of the visual object 922. As a non-limiting example, the visual effect 925 may express a third color different from each of the first color and the second color.

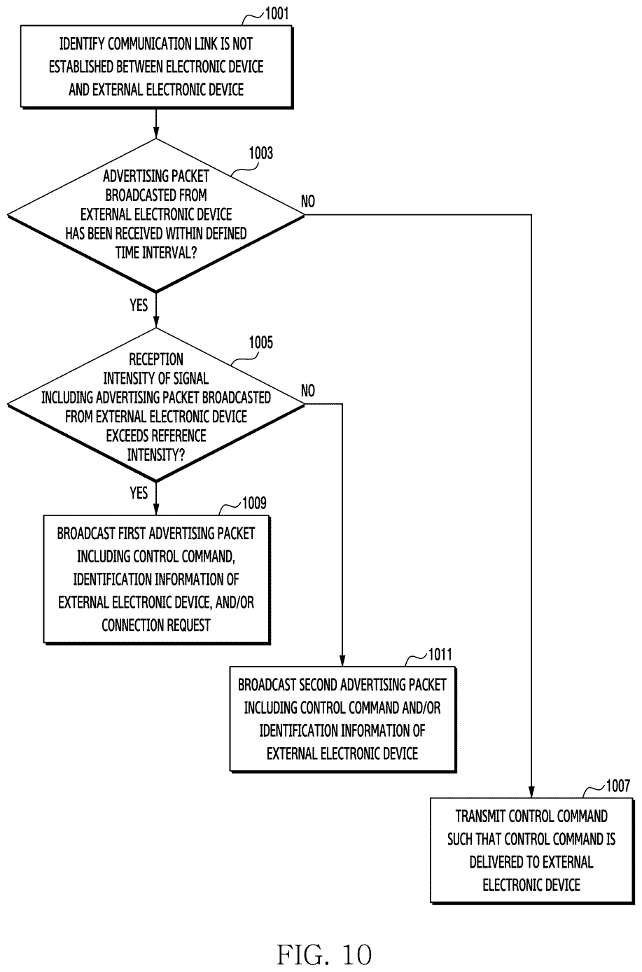

FIG. 10 illustrates an example of operations of an electronic device for controlling an external electronic device when a communication link is not established between the electronic device and the external electronic device according to an embodiment of the disclosure.

Operations of the electronic device (e.g., an electronic device 301) exemplified in FIG. 10 may be executed, performed, or controlled by at least one processor (e.g., at least one processor 300).

Referring to FIG. 10, in operation 1001, the electronic device 301 may identify that a communication link (e.g., a communication link 421 or 531) is not established between the electronic device 301 and an external electronic device (e.g., an external electronic device 202, an external electronic device 411, or an external electronic device 412). For example, the operation 1001 may be referred to as an operation after the operation 443 of FIG. 4B. For example, in order for the electronic device 301 to identify that the communication link is not established, descriptions of the operation 443 of FIG. 4B may be referenced.

In operation 1003, the electronic device 301 may identify whether an advertising packet (e.g., an advertising packet 602) broadcasted from the external electronic device has been received within a defined time interval. For example, the electronic device 301 may identify whether a signal including the advertising packet (e.g., the advertising packet 602) broadcasted from the external electronic device has been received within the defined time interval. For example, the electronic device 301 may execute operation 1005 based on identifying that the advertising packet is received within the defined time interval. The electronic device 301 may execute operation 1007 based on identifying that the advertising packet is not received within the defined time interval. For example, the defined time interval may indicate a time interval at which the electronic device 301 may receive the advertising packet (e.g., the advertising packet 602) broadcasted from the external electronic device. For example, the defined time interval may be related to a scan period. For example, the defined time interval may be referred to as a scan window of the scan period.

In operation 1005, the electronic device 301 may identify whether reception intensity of the signal including the advertising packet broadcasted from the external electronic device exceeds reference intensity, based on identifying that the advertising packet (e.g., the advertising packet 602) broadcasted from the external electronic device is received within the defined time interval. The reception intensity of the signal may include a received signal strength indicator (RSSI). For example, as a distance between the electronic device 301 and the external electronic device is farther, the reception intensity of the signal may be lower. For example, as the reception intensity of the signal is lower, communication quality between the electronic device 301 and the external electronic device may be lower. For example, descriptions of the reference intensity of FIG. 7 may be referenced for the reference intensity.

In operation 1007, the electronic device 301 may transmit a control command (e.g., a control command 611) using communication circuitry (e.g., second communication circuitry 330-2) such that the control command is delivered to the external electronic device, based on identifying that the advertising packet (e.g., the advertising packet 602) broadcasted from the external electronic device is not received within the defined time interval. For example, in a case that the advertising packet is not received within the defined time interval, the distance between the electronic device 301 and the external electronic device may be relatively large. For example, in a case that the advertising packet is not received within the defined time interval, there may be relatively many communication interference elements (e.g., noise) between the electronic device 301 and the external electronic device. For example, in a case that the advertising packet (e.g., the advertising packet 602) is not received within the defined time interval, the electronic device 301 may not utilize a method of communicating with the external electronic device through the communication link (e.g., the communication link 421 or 531). In a case that the advertising packet 602 is not received within the defined time interval, the electronic device 301 may not control the external electronic device through the communication link (e.g., the communication link 421 or 531). For example, in a case that the advertising packet (e.g., the advertising packet 602) is not received within the defined time interval, the electronic device 301 may not utilize a method of broadcasting an advertising packet (e.g., the advertising packet 431, 511, or 601) including a control command. For example, in a case that the advertising packet (e.g., the advertising packet 602) is not received within the defined time interval, the electronic device 301 may not control the external electronic device through broadcasting of the advertising packet (e.g., the advertising packet 431, 511, or 601) including the control command.

According to an embodiment, the electronic device 301 may transmit the control command (e.g., the control command 611) to a relay device using the communication circuitry (e.g., the second communication circuitry 330-2). For example, the electronic device 301 may transmit the control command to the relay device using the communication circuitry (e.g., the second communication circuitry 330-2) such that the control command is delivered to the external electronic device. For example, the relay device may be referred to as a device for transmitting or controlling the control command transmitted from the electronic device 301 to the external electronic device. The relay device may be referred to as a relay node. For example, the relay device may include a server device (e.g., a server device 203), a hub device, and/or an access point (AP), but an embodiment is not limited thereto. For example, the relay device may transmit the control command to the external electronic device in response to receiving the control command from the electronic device 301. For example, the electronic device 301 may control the external electronic device through the relay device.

In operation 1009, the electronic device 301 may broadcast a first advertising packet including a control command, identification information of the external electronic device, and/or a connection request, based on identifying that the reception intensity of the signal including the advertising packet (e.g., the advertising packet 602) broadcasted from the external electronic device exceeds the reference intensity. The electronic device 301 may cause the external electronic device to start a process for a communication link according to the connection request after providing a function corresponding to the control command based on identifying that the reception intensity of the signal exceeds the reference intensity.

In operation 1011, the electronic device 301 may broadcast a second advertising packet including the control command and/or the identification information of the external electronic device, based on identifying that the reception intensity of the signal including the advertising packet (e.g., the advertising packet 602) broadcasted from the external electronic device does not exceed the reference intensity. For example, the second advertising packet may not include the connection request. For example, the second advertising packet may include the control command and the identification information of the external electronic device, from among the control command, the identification information of the external electronic device, and the connection request. For example, the electronic device 301 may cause the external electronic device to provide the function corresponding to the control command and then not start the process for the communication link according to the connection request, based on identifying that the reception intensity of the signal does not exceed the reference intensity.

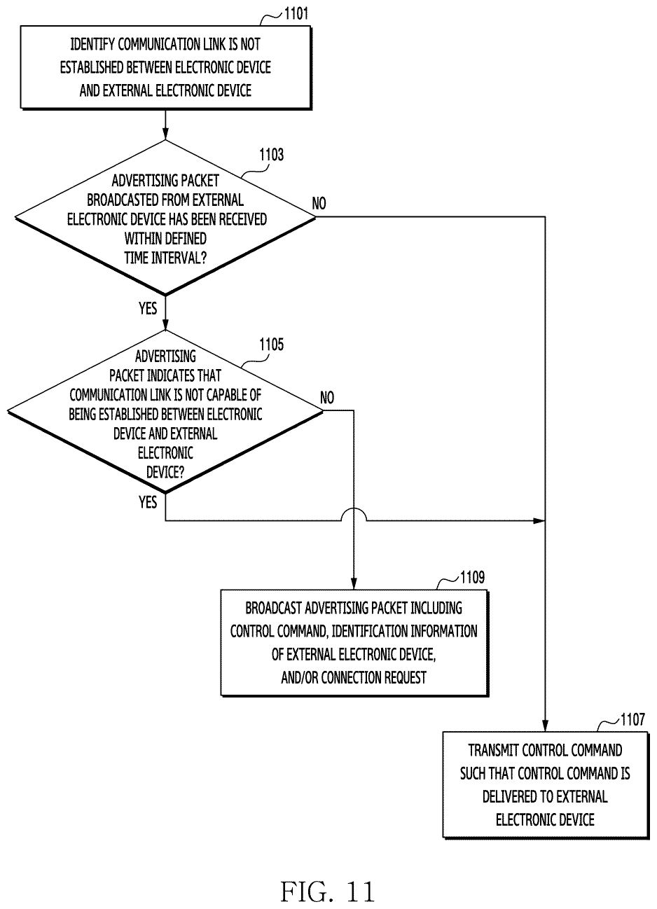

FIG. 11 illustrates an example of operations of an electronic device for controlling an external electronic device when a communication link is not established between the electronic device and the external electronic device according to an embodiment of the disclosure.

Operations of the electronic device (e.g., an electronic device 301) exemplified in FIG. 11 may be executed, performed, or controlled by at least one processor (e.g., at least one processor 300).

Referring to FIG. 11, in operation 1101, the electronic device 301 may identify that a communication link is not established between the electronic device 301 and an external electronic device (e.g., an external electronic device 202, an external electronic device 411, or an external electronic device 412). For example, the operation 1101 may be referred to as an operation after the operation 443 of FIG. 4B. For example, in order for the electronic device 301 to identify that the communication link is not established, descriptions of the operation 443 of FIG. 4B may be referenced. For example, the operation 1101 may correspond to the operation 1001 of FIG. 10.

In operation 1103, the electronic device 301 may identify whether an advertising packet (e.g., an advertising packet 602) broadcasted from the external electronic device has been received within a defined time interval. For example, the electronic device 301 may identify whether a signal including the advertising packet 602 broadcasted from the external electronic device has been received within the defined time interval. As an example, the electronic device 301 may execute operation 1105 based on identifying that the advertising packet is received within the defined time interval. For example, the electronic device 301 may execute operation 1107 based on identifying that the advertising packet is not received within the defined time interval. For example, descriptions of the operation 1003 of FIG. 10 may be referenced for the defined time interval. For example, the operation 1103 may correspond to the operation 1003 of FIG. 10.

In operation 1105, the electronic device 301 may identify whether the advertising packet (e.g., the advertising packet 602) indicates that the communication link is not capable of being established between the electronic device 301 and the external electronic device. For example, the electronic device 301 may execute the operation 1107 based on the advertising packet (e.g., the advertising packet 602) indicating that the communication link is not capable of being established. For example, the electronic device 301 may execute operation 1109 based on the advertising packet (e.g., the advertising packet 602) indicating that the communication link is capable of being established.

According to an embodiment, the external electronic device may broadcast the advertising packet (e.g., the advertising packet 602) indicating that the communication link is not capable of being established based on identifying that an amount of resource related to the communication link is less than a reference amount for establishing the communication link. For example, the external electronic device may broadcast the advertising packet (e.g., the advertising packet 602) indicating that the communication link is not capable of being established between electronic devices 301 and the external electronic device since the external electronic device is establishing a communication link with another external electronic device. For example, the external electronic device may broadcast the advertising packet indicating that the communication link is not capable of being established between the electronic devices 301 and the external electronic device since the external electronic device provides a BLE service for the other external electronic device.

In operation 1107, the electronic device 301 may transmit a control command using communication circuitry (e.g., second communication circuitry 330-2) such that the control command is delivered to the external electronic device. For example, the operation 1107 may correspond to the operation 1007 of FIG. 10. For example, descriptions of the operation 1007 of FIG. 10 may be referenced for the operation 1107.

In operation 1109, the electronic device 301 may broadcast an advertising packet including a control command, identification information of the external electronic device, and/or a connection request. For example, the operation 1109 may correspond to the operation 1009 of FIG. 10. For example, descriptions of the operation 1009 of FIG. 10 may be referenced for the operation 1109.

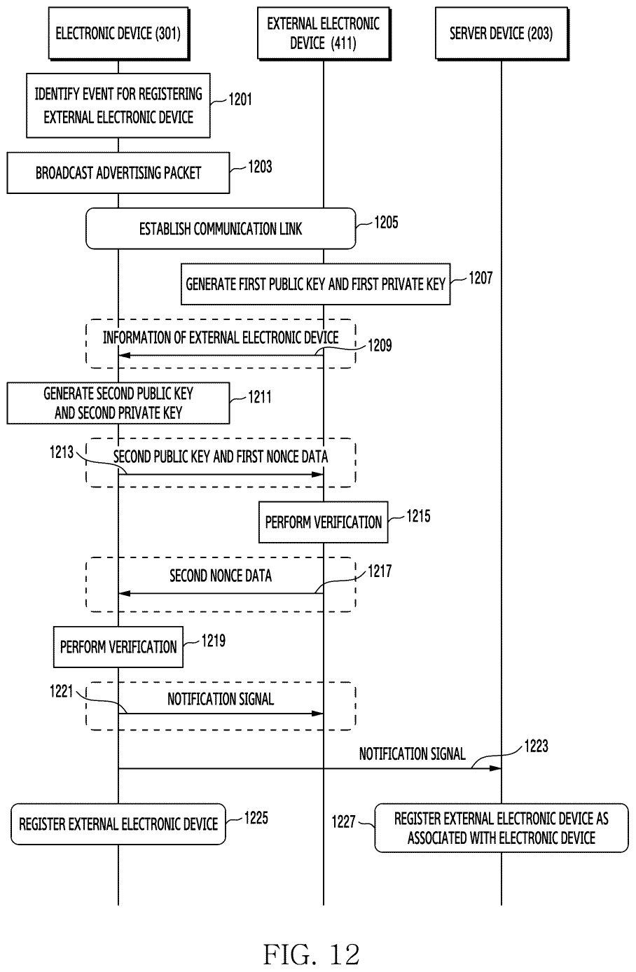

FIG. 12 illustrates an example of operations in which an external electronic device is registered in each of an electronic device and a server device according to an embodiment of the disclosure.

Operations of the electronic device (e.g., an electronic device 301) exemplified in FIG. 12 may be executed, performed, or controlled by at least one processor (e.g., at least one processor 300). Although an external electronic device 411 is illustrated in FIG. 12, even if the external electronic device 411 is replaced with external electronic devices 202, 412, 711, 712, and 713, it may be understood as an embodiment of the disclosure.

Referring to FIG. 12, in operation 1201, the electronic device 301 may identify an event for registering the external electronic device 411. As a non-limiting example, the event for registering the external electronic device 411 may include an out of box experience (OOBE). For example, the OOBE may be referred to as a setting process first experienced by a user after opening the external electronic device 411. As a non-limiting example, the event for registering the external electronic device 411 may include photographing or scanning a quick response (QR) code indicating the external electronic device 411 using a camera of the electronic device 301. For example, by photographing the QR code indicating the external electronic device 411 using the camera of the electronic device 301, an authentication key related to the external electronic device 411 may be obtained. For example, the authentication key may be referred to as a device to device (D2D) key and/or a pairing key.

As a non-limiting example, the electronic device 301 may receive information on an application (e.g., a control application) for controlling the external electronic device 411 from the server device using communication circuitry (e.g., communication circuitry 330) by photographing the QR code indicating the external electronic device 411 using the camera of the electronic device 301. For example, the electronic device 301 may install the application for controlling the external electronic device 411 according to the information on the application (e.g., the control application) for controlling the external electronic device 411.

In operation 1203, the electronic device 301 may broadcast an advertising packet using communication circuitry (e.g., first communication circuitry 330-1). The advertising packet broadcasted from the electronic device 301 may be received by the external electronic device 411. For example, the advertising packet may be used to establish a communication connection.

In operation 1205, the electronic device 301 may establish a communication link between the electronic device 301 and the external electronic device 411. The external electronic device 411 may establish the communication link between the electronic device 301 and the external electronic device 411. For example, the communication link may include a GATT connection.

In operation 1207, the external electronic device 411 may generate a first public key and a first private key. For example, the first public key and the first private key may be associated with each other.

In operation 1209, the external electronic device 411 may transmit information of the external electronic device 411 to the electronic device 301 through the communication link. For example, the information of the external electronic device 411 may include the first public key, identification information of the external electronic device 411, and/or version information of a software of the external electronic device 411. The identification information of the external electronic device 411 may be represented as a hash value of 32 bits according to a hash function. For example, the information of the external electronic device 411 may be encrypted using the first private key.

According to an embodiment, the electronic device 301 may decrypt the information of the external electronic device 411 by using the first public key. For example, as the electronic device 301 decrypts the information of the external electronic device 411 using the first public key, authentication for the external electronic device 411 may be performed.

In operation 1211, the electronic device 301 may generate a second public key and a second private key. For example, the second public key and the second private key may be associated with each other.

In operation 1213, the electronic device 301 may transmit the second public key and/or first nonce data to the external electronic device 411 through the communication link. For example, the first nonce data may represent a hash value of 256 bits. For example, the first nonce data may be generated using the authentication key and the first public key. For example, the first nonce data may be generated by applying a hash function (e.g., SHA-256) to the authentication key and the first public key.

In operation 1215, the external electronic device 411 may verify the first nonce data. The external electronic device 411 may generate at least one spare key by applying a hash function to the authentication key and time information. For example, the external electronic device 411 may generate a spare key by applying a hash function to the authentication key and information indicating a current time. For example, the external electronic device 411 may generate a spare key by applying a hash function to the authentication key and information indicating a time (e.g., 1 hour before) prior to the current time. The external electronic device 411 may generate a spare key by applying a hash function to the authentication key and information indicating a time later (e.g., 1 hour after) than the current time. For example, the external electronic device 411 may identify success of the verification by identifying that at least one spare key corresponds to the first nonce data. For example, the external electronic device 411 may generate a security key based on identifying the success of the verification. For example, the security key may be referred to as a session key.

In operation 1217, the external electronic device 411 may transmit second nonce data to the electronic device 301 through the communication link. For example, the second nonce data may represent a hash value of 256 bits. For example, the second nonce data may be generated using an authentication key and a second public key. For example, the second nonce data may be generated by applying the hash function (e.g., SHA-256) to the authentication key and the second public key. As a non-limiting example, in operation 1217, the external electronic device 411 may further transmit an initialization function to the electronic device 301 through the communication link.

In operation 1219, the electronic device 301 may verify the second nonce data. For example, the electronic device 301 may generate a security key based on performing verification on the second nonce data. For example, the security key may be referred to as a session key. For example, the security key generated by the external electronic device 411 in operation 1215 may correspond to the security key generated by the electronic device 301 in operation 1219. For example, the security key generated by the external electronic device 411 in operation 1215 may be the same as the security key generated by the electronic device 301 in operation 1219. For example, the security key may be shared with the electronic device 301 and the external electronic device 411.

In operation 1221, the electronic device 301 may transmit a notification signal to the external electronic device 411 through the communication link. For example, the notification signal may indicate that the security key is generated according to the verification of the second nonce data. For example, the electronic device 301 and the external electronic device 411 may perform mutual authentication using the security key.

In operation 1223, the electronic device 301 may transmit the notification signal to a server device 203 using communication circuitry (e.g., second communication circuitry 330-2). For example, the notification signal may indicate that the electronic device 301 and the external electronic device 411 share the security key. For example, the notification signal may indicate that the electronic device 301 and the external electronic device 411 are authenticated with each other.

In operation 1225, the electronic device 301 may register the external electronic device 411. For example, the electronic device 301 may register the external electronic device 411 through the control application.

In operation 1227, the server device 203 may register the external electronic device 411 as associated with the electronic device 301. For example, the server device 203 may register the electronic device 301 as associated with the external electronic device 411.

In an embodiment according to the disclosure, an electronic device (e.g., the electronic device 301) may control an external electronic device (e.g., the external electronic device 202, 411, or 412) by using a method of broadcasting an advertising packet (e.g., the advertising packet 431, 511, or 601) including a control command (e.g., the control command 611). For example, by controlling the external electronic device using the method, the electronic device 301 may relatively reduce a time difference between a timing at which a user input is received in the electronic device 301 and a timing at which the external electronic device is controlled. For example, as the time difference is reduced, user experience of the electronic device 301 may be enhanced. In addition, the electronic device 301 may establish a communication link only when the communication link is substantially utilized between the electronic device 301 and the external electronic device. The electronic device 301 may relatively reduce an amount of use of a battery resource by establishing the communication link only when the communication link is substantially utilized between the electronic device 301 and the external electronic device.

The effects that may be obtained from the disclosure are not limited to those described above, and any other effects not mentioned herein will be clearly understood by those having ordinary knowledge in the art to which the disclosure belongs, from the following description.

The technical problems to be achieved in this document are not limited to those described above, and other technical problems not mentioned herein will be clearly understood by those having ordinary knowledge in the art to which the disclosure belongs, from the following description.

As described above, an electronic device may comprise communication circuitry. The electronic device may comprise memory comprising one or more storage media storing instructions. The electronic device may comprise at least one processor comprising processing circuitry. The instructions, when executed by the at least one processor individually or collectively, may cause the electronic device to receive a user input for controlling an external electronic device registered in the electronic device. The instructions, when executed by the at least one processor individually or collectively, may cause the electronic device to identify whether a communication link is not established between the electronic device and the external electronic device. The instructions, when executed by the at least one processor individually or collectively, may cause the electronic device to, based on identifying that the communication link is not established between the electronic device and the external electronic device, broadcast an advertising packet, including a control command generated in accordance with the user input, identification information of the external electronic device, and a connection request for establishing the communication link between the electronic device and the external electronic device, for allowing the external electronic device to provide a function corresponding to the control command before the communication link is established. The instructions, when executed by the at least one processor individually or collectively, may cause the electronic device to, based on identifying that the communication link has been established between the electronic device and the external electronic device, transmit, using the communication circuitry to the external electronic device, via the communication link, a packet including the control command generated in accordance with the user input.

According to an embodiment, the user input may be a first user input. The advertising packet may be a first advertising packet. The instructions, when executed by the at least one processor individually or collectively, may cause the electronic device to, after broadcasting the first advertising packet, receive a second user input for controlling the external electronic device. The instructions, when executed by the at least one processor individually or collectively, may cause the electronic device to, based on the second user input being received before the communication link is established between the electronic device and the external electronic device in accordance with the connection request included in the first advertising packet, broadcast a second advertising packet including a control command generated in accordance with the second user input and the identification information of the external electronic device, without the connection request.

According to an embodiment, the user input may be a first user input. The advertising packet may be a first advertising packet. The instructions, when executed by the at least one processor individually or collectively, may cause the electronic device to, after broadcasting the first advertising packet, receive a second user input for controlling the external electronic device. The instructions, when executed by the at least one processor individually or collectively, may cause the electronic device to, based on the second user input being received before the communication link is established between the electronic device and the external electronic device in accordance with the connection request included in the first advertising packet, broadcast a second advertising packet including a control command generated in accordance with the second user input, the identification information of the external electronic device, and the connection request.

According to an embodiment, the communication circuitry may be first communication circuitry. The electronic device may comprise second communication circuitry. The instructions, when executed by the at least one processor individually or collectively, may cause the electronic device to, based on identifying that the communication link is not established between the electronic device and the external electronic device, identify, using the first communication circuitry, whether an advertising packet broadcasted from the external electronic device is received within a defined time interval. The instructions, when executed by the at least one processor individually or collectively, may cause the electronic device to, based on identifying that the advertising packet broadcasted from the external electronic device is received within the defined time interval, broadcast, using the first communication circuitry, the advertising packet, including the control command, the identification information of the external electronic device, and the connection request, for allowing the external electronic device to provide the function corresponding to the control command before the communication link is established. The instructions, when executed by the at least one processor individually or collectively, may cause the electronic device to, based on identifying that the advertising packet broadcasted from the external electronic device is not received within the defined time interval, transmit, using the second communication circuitry, the control command such that the control command is delivered to the external electronic device.

According to an embodiment, the instructions, when executed by the at least one processor individually or collectively, may cause the electronic device to, based on identifying that the advertising packet broadcasted from the external electronic device is received within the defined time interval, identify reception intensity of a signal including the advertising packet broadcasted from the external electronic device. The instructions, when executed by the at least one processor individually or collectively, may cause the electronic device to, based on identifying that the reception intensity of the signal is greater than reference intensity, broadcast, using the first communication circuitry, the advertising packet, including the control command, the identification information of the external electronic device, and the connection request, for allowing the external electronic device to provide the function corresponding to the control command before the communication link is established. The instructions, when executed by the at least one processor individually or collectively, may cause the electronic device to, based on identifying that the reception intensity of the signal is less than the reference intensity, broadcast, using the first communication circuitry, another advertising packet including the control command generated in accordance with the user input and the identification information of the external electronic device, without the connection request.

According to an embodiment, the communication circuitry may be first communication circuitry. The electronic device may comprise second communication circuitry. The instructions, when executed by the at least one processor individually or collectively, may cause the electronic device to, based on identifying that the communication link is not established between the electronic device and the external electronic device, identify, using the first communication circuitry, whether an advertising packet indicating that the communication link is not capable of being established between the electronic device and the external electronic device is received from the external electronic device within a defined time interval. The instructions, when executed by the at least one processor individually or collectively, may cause the electronic device to, based on identifying that the advertising packet is not received from the external electronic device within the defined time interval, broadcast, using the first communication circuitry, the advertising packet, including the control command, the identification information of the external electronic device, and the connection request, for allowing the external electronic device to provide the function corresponding to the control command before the communication link is established. The instructions, when executed by the at least one processor individually or collectively, may cause the electronic device to, based on identifying that the advertising packet is received from the external electronic device within the defined time interval, transmit, using the second communication circuitry, the control command such that the control command is delivered to the external electronic device.

According to an embodiment, the instructions, when executed by the at least one processor individually or collectively, may cause the electronic device to, based on identifying that the communication link is not established between the electronic device and the external electronic device, periodically broadcast, using the communication circuitry, the advertising packet until the communication link is established between the electronic device and the external electronic device.

According to an embodiment, the electronic device may comprise a display. The instructions, when executed by the at least one processor individually or collectively, may cause the electronic device to display, using the display, a visual object for receiving the user input. The visual object, based on the communication link having been established between the electronic device and the external electronic device, may represent a first visual effect. The visual object, based on the communication link not being established between the electronic device and the external electronic device, may represent a second visual effect distinct from the first visual effect.

According to an embodiment, the control command generated in accordance with the user input may include a wake-up command to change a state of the external electronic device from a standby state to an activation state.

According to an embodiment, the identification information of the external electronic device may include a media access control (MAC) address of the external electronic device.

According to an embodiment, the instructions, when executed by the at least one processor individually or collectively, may cause the electronic device to, based on identifying that the communication link is not established between the electronic device and the external electronic device, in accordance with a system resource of the electronic device capable of establishing the communication link between the electronic device and the external electronic device, broadcast, using the communication circuitry, the advertising packet, including the control command, the identification information of the external electronic device, and the connection request, for allowing the external electronic device to provide the function corresponding to the control command before the communication link is established. The instructions, when executed by the at least one processor individually or collectively, may cause the electronic device to, based on identifying that the communication link is not established between the electronic device and the external electronic device, in accordance with the system resource of the electronic device not capable of establishing the communication link between the electronic device and the external electronic device, broadcast, using the communication circuitry, another advertising packet including the control command and the identification information of the external electronic device, without the connection request.

According to an embodiment, the instructions, when executed by the at least one processor individually or collectively, may cause the electronic device to, change a state of the external electronic device from a turn-off state to a turn-on state.

According to an embodiment, the instructions, when executed by the at least one processor individually or collectively, may cause the electronic device to, register the electronic device and the external electronic device via a server.

As described above, a method performed by an electronic device with communication circuitry may comprise receiving a user input for controlling an external electronic device registered in the electronic device. The method may comprise identifying whether a communication link is not established between the electronic device and the external electronic device. The method may comprise, based on identifying that the communication link is not established between the electronic device and the external electronic device, broadcasting an advertising packet, including a control command generated in accordance with the user input, identification information of the external electronic device, and a connection request for establishing the communication link between the electronic device and the external electronic device, for allowing the external electronic device to provide a function corresponding to the control command before the communication link is established. The method may comprise, based on identifying that the communication link has been established between the electronic device and the external electronic device, transmitting, using the communication circuitry to the external electronic device, via the communication link, a packet including the control command generated in accordance with the user input.

According to an embodiment, the user input may be a first user input. The advertising packet may be a first advertising packet. The method may comprise, after broadcasting the first advertising packet, receiving a second user input for controlling the external electronic device. The method may comprise, based on the second user input being received before the communication link is established between the electronic device and the external electronic device in accordance with the connection request included in the first advertising packet, broadcasting a second advertising packet including a control command generated in accordance with the second user input and the identification information of the external electronic device, without the connection request.

According to an embodiment, the user input may be a first user input. The advertising packet may be a first advertising packet. The method may comprise, after broadcasting the first advertising packet, receiving a second user input for controlling the external electronic device. The method may comprise, based on the second user input being received before the communication link is established between the electronic device and the external electronic device in accordance with the connection request included in the first advertising packet, broadcasting a second advertising packet including a control command generated in accordance with the second user input, the identification information of the external electronic device, and the connection request.

According to an embodiment, the communication circuitry may be first communication circuitry. The electronic device may comprise second communication circuitry. The method may comprise, based on identifying that the communication link is not established between the electronic device and the external electronic device, identifying, using the first communication circuitry, whether an advertising packet broadcasted from the external electronic device is received within a defined time interval. The method may comprise, based on identifying that the advertising packet broadcasted from the external electronic device is received within the defined time interval, broadcasting, using the first communication circuitry, the advertising packet, including the control command, the identification information of the external electronic device, and the connection request, for allowing the external electronic device to provide the function corresponding to the control command before the communication link is established. The method may comprise, based on identifying that the advertising packet broadcasted from the external electronic device is not received within the defined time interval, transmitting, using the second communication circuitry, the control command such that the control command is delivered to the external electronic device.

According to an embodiment, the method may comprise, based on identifying that the advertising packet broadcasted from the external electronic device is received within the defined time interval, identifying reception intensity of a signal including the advertising packet broadcasted from the external electronic device. The method may comprise, based on identifying that the reception intensity of the signal is greater than reference intensity, broadcasting, using the first communication circuitry, the advertising packet, including the control command, the identification information of the external electronic device, and the connection request, for allowing the external electronic device to provide the function corresponding to the control command before the communication link is established. The method may comprise, based on identifying that the reception intensity of the signal is less than the reference intensity, broadcasting, using the first communication circuitry, another advertising packet including the control command generated in accordance with the user input and the identification information of the external electronic device, without the connection request.

According to an embodiment, the communication circuitry may be first communication circuitry. The electronic device may comprise second communication circuitry. The method may comprise, based on identifying that the communication link is not established between the electronic device and the external electronic device, identifying, using the first communication circuitry, whether an advertising packet indicating that the communication link is not capable of being established between the electronic device and the external electronic device is received from the external electronic device within a defined time interval. The method may comprise, based on identifying that the advertising packet is not received from the external electronic device within the defined time interval, broadcasting, using the first communication circuitry, the advertising packet, including the control command, the identification information of the external electronic device, and the connection request, for allowing the external electronic device to provide the function corresponding to the control command before the communication link is established. The method may comprise, based on identifying that the advertising packet is received from the external electronic device within the defined time interval, transmitting, using the second communication circuitry, the control command such that the control command is delivered to the external electronic device.

According to an embodiment, the method may comprise, based on identifying that the communication link is not established between the electronic device and the external electronic device, periodically broadcasting, using the communication circuitry, the advertising packet until the communication link is established between the electronic device and the external electronic device.

According to an embodiment, the electronic device may comprise a display. The method may comprise displaying, using the display, a visual object for receiving the user input. The visual object, based on the communication link having been established between the electronic device and the external electronic device, may represent a first visual effect. The visual object, based on the communication link not being established between the electronic device and the external electronic device, may represent a second visual effect distinct from the first visual effect.

According to an embodiment, the control command generated in accordance with the user input may include a wake-up command to change a state of the external electronic device from a standby state to an activation state.

According to an embodiment, the identification information of the external electronic device may include a media access control (MAC) address of the external electronic device.

According to an embodiment, the method may comprise, based on identifying that the communication link is not established between the electronic device and the external electronic device, in accordance with a system resource of the electronic device capable of establishing the communication link between the electronic device and the external electronic device, broadcasting, using the communication circuitry, the advertising packet, including the control command, the identification information of the external electronic device, and the connection request, for allowing the external electronic device to provide the function corresponding to the control command before the communication link is established. The method may comprise, based on identifying that the communication link is not established between the electronic device and the external electronic device, in accordance with the system resource of the electronic device not capable of establishing the communication link between the electronic device and the external electronic device, broadcasting, using the communication circuitry, another advertising packet including the control command and the identification information of the external electronic device, without the connection request.

According to an embodiment, the method may comprise changing a state of the external electronic device from a turn-off state to a turn-on state.

According to an embodiment, the method may comprise registering the electronic device and the external electronic device via a server.

As described above, in one or more non-transitory computer readable storage media, the one or more non-transitory computer readable storage media may store one or more computer programs. The one or more computer programs may include computer-executable instructions that, when executed by at least one processor of an electronic device with communication circuitry individually or collectively, cause the electronic device to perform operations. The operations may include identifying whether a communication link is not established between the electronic device and the external electronic device. The operations may include, based on identifying that the communication link is not established between the electronic device and the external electronic device, broadcasting an advertising packet, including a control command generated in accordance with the user input, identification information of the external electronic device, and a connection request for establishing the communication link between the electronic device and the external electronic device, for allowing the external electronic device to provide a function corresponding to the control command before the communication link is established. The operations may include, based on identifying that the communication link has been established between the electronic device and the external electronic device, transmitting, using the communication circuitry to the external electronic device, via the communication link, a packet including the control command generated in accordance with the user input.

According to an embodiment, the user input may be a first user input. The advertising packet may be a first advertising packet. The operations may include, after broadcasting the first advertising packet, receiving a second user input for controlling the external electronic device. The operations may include, based on the second user input being received before the communication link is established between the electronic device and the external electronic device in accordance with the connection request included in the first advertising packet, broadcasting a second advertising packet including a control command generated in accordance with the second user input and the identification information of the external electronic device, without the connection request.

According to an embodiment, the user input may be a first user input. The advertising packet may be a first advertising packet. The operations may include, after broadcasting the first advertising packet, receiving a second user input for controlling the external electronic device. The operations may include, based on the second user input being received before the communication link is established between the electronic device and the external electronic device in accordance with the connection request included in the first advertising packet, broadcasting a second advertising packet including a control command generated in accordance with the second user input, the identification information of the external electronic device, and the connection request.

According to an embodiment, the communication circuitry may be first communication circuitry. The electronic device may comprise second communication circuitry. The operations may include, based on identifying that the communication link is not established between the electronic device and the external electronic device, identifying, using the first communication circuitry, whether an advertising packet broadcasted from the external electronic device is received within a defined time interval. The operations may include, based on identifying that the advertising packet broadcasted from the external electronic device is received within the defined time interval, broadcasting, using the first communication circuitry, the advertising packet, including the control command, the identification information of the external electronic device, and the connection request, for allowing the external electronic device to provide the function corresponding to the control command before the communication link is established. The operations may include, based on identifying that the advertising packet broadcasted from the external electronic device is not received within the defined time interval, transmitting, using the second communication circuitry, the control command such that the control command is delivered to the external electronic device.

According to an embodiment, the operations may include, based on identifying that the advertising packet broadcasted from the external electronic device is received within the defined time interval, identifying reception intensity of a signal including the advertising packet broadcasted from the external electronic device. The operations may include, based on identifying that the reception intensity of the signal is greater than reference intensity, broadcasting, using the first communication circuitry, the advertising packet, including the control command, the identification information of the external electronic device, and the connection request, for allowing the external electronic device to provide the function corresponding to the control command before the communication link is established. The operations may include, based on identifying that the reception intensity of the signal is less than the reference intensity, broadcasting, using the first communication circuitry, another advertising packet including the control command generated in accordance with the user input and the identification information of the external electronic device, without the connection request.

According to an embodiment, the communication circuitry may be first communication circuitry. The electronic device may comprise second communication circuitry. The operations may include, based on identifying that the communication link is not established between the electronic device and the external electronic device, identifying, using the first communication circuitry, whether an advertising packet indicating that the communication link is not capable of being established between the electronic device and the external electronic device is received from the external electronic device within a defined time interval. The operations may include, based on identifying that the advertising packet is not received from the external electronic device within the defined time interval, broadcasting, using the first communication circuitry, the advertising packet, including the control command, the identification information of the external electronic device, and the connection request, for allowing the external electronic device to provide the function corresponding to the control command before the communication link is established. The operations may include, based on identifying that the advertising packet is received from the external electronic device within the defined time interval, transmitting, using the second communication circuitry, the control command such that the control command is delivered to the external electronic device.

According to an embodiment, the operations may include, based on identifying that the communication link is not established between the electronic device and the external electronic device, periodically broadcasting, using the communication circuitry, the advertising packet until the communication link is established between the electronic device and the external electronic device.

According to an embodiment, the electronic device may comprise a display. The operations may include displaying, using the display, a visual object for receiving the user input. The visual object, based on the communication link having been established between the electronic device and the external electronic device, may represent a first visual effect. The visual object, based on the communication link not being established between the electronic device and the external electronic device, may represent a second visual effect distinct from the first visual effect.

According to an embodiment, the control command generated in accordance with the user input may include a wake-up command to change a state of the external electronic device from a standby state to an activation state.

According to an embodiment, the identification information of the external electronic device may include a media access control (MAC) address of the external electronic device.

According to an embodiment, the operations may include, based on identifying that the communication link is not established between the electronic device and the external electronic device, in accordance with a system resource of the electronic device capable of establishing the communication link between the electronic device and the external electronic device, broadcasting, using the communication circuitry, the advertising packet, including the control command, the identification information of the external electronic device, and the connection request, for allowing the external electronic device to provide the function corresponding to the control command before the communication link is established. The operations may include, based on identifying that the communication link is not established between the electronic device and the external electronic device, in accordance with the system resource of the electronic device not capable of establishing the communication link between the electronic device and the external electronic device, broadcasting, using the communication circuitry, another advertising packet including the control command and the identification information of the external electronic device, without the connection request.

According to an embodiment, the operations may include, changing a state of the external electronic device from a turn-off state to a turn-on state.

According to an embodiment, the operations may include, registering the electronic device and the external electronic device via a server.

For one or more embodiments, at least one of components described in one or more of the preceding drawings may be configured to perform one or more operations, techniques, processes and/or methods as described in the disclosure. For example, a processor (e.g., a baseband processor) described in the disclosure in relation to one or more of the preceding drawings may be configured to operate according to one or more examples described in the disclosure. For another example, circuitry associated with user equipment (UE), a base station, a network element, and the like, as described above in relation to one or more of the preceding drawings, may be configured to operate according to one or more examples described herein.

Any of the embodiments described above may be combined with any other embodiment (or a combination of embodiments), unless explicitly stated otherwise. The above-described description of one or more implementations provides an example and a description, but is not intended to limit or thoroughly limit the scope of an embodiments in a precise form disclosed. In light of the above teachings, modifications and variations are possible, or may be derived from the implementations of various embodiments.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

In an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to some embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

No claim element is to be construed under the provisions of 35 U.S.C. §112, sixth paragraph, unless the element is expressly recited using the phrase “means for“ or ”means”.

What is claimed is:

1. An electronic device comprising:
communication circuitry;
at least one processor comprising processing circuitry; and
memory comprising one or more storage media storing instructions that, when executed by the at least one processor individually or collectively, cause the electronic device to:
receive a user input for controlling an external electronic device registered in the electronic device,
identify whether a communication link is not established between the electronic device and the external electronic device,
based on identifying that the communication link is not established between the electronic device and the external electronic device, broadcast an advertising packet, including a control command generated in accordance with the user input, identification information of the external electronic device, and a connection request for establishing the communication link between the electronic device and the external electronic device, for allowing the external electronic device to provide a function corresponding to the control command before the communication link is established, and
based on identifying that the communication link has been established between the electronic device and the external electronic device, transmit, using the communication circuitry to the external electronic device, via the communication link, a packet including the control command generated in accordance with the user input.

2. The electronic device of claim 1,
wherein the user input is a first user input,
wherein the advertising packet is a first advertising packet, and
wherein the instructions, when executed by the at least one processor individually or collectively, further cause the electronic device to:
after broadcasting the first advertising packet, receive a second user input for controlling the external electronic device, and
based on the second user input being received before the communication link is established between the electronic device and the external electronic device in accordance with the connection request included in the first advertising packet, broadcast a second advertising packet including a control command generated in accordance with the second user input and the identification information of the external electronic device, without the connection request.

3. The electronic device of claim 1,
wherein the user input is a first user input,
wherein the advertising packet is a first advertising packet, and
wherein the instructions, when executed by the at least one processor individually or collectively, further cause the electronic device to:
after broadcasting the first advertising packet, receive a second user input for controlling the external electronic device, and
based on the second user input being received before the communication link is established between the electronic device and the external electronic device in accordance with the connection request included in the first advertising packet, broadcast a second advertising packet including a control command generated in accordance with the second user input, the identification information of the external electronic device, and the connection request.

4. The electronic device of claim 1,
wherein the communication circuitry is first communication circuitry,
wherein the electronic device comprises second communication circuitry, and
wherein the instructions, when executed by the at least one processor individually or collectively, cause the electronic device to:
based on identifying that the communication link is not established between the electronic device and the external electronic device, identify, using the first communication circuitry, whether an advertising packet broadcasted from the external electronic device is received within a defined time interval,
based on identifying that the advertising packet broadcasted from the external electronic device is received within the defined time interval, broadcast, using the first communication circuitry, the advertising packet, including the control command, the identification information of the external electronic device, and the connection request, for allowing the external electronic device to provide the function corresponding to the control command before the communication link is established, and
based on identifying that the advertising packet broadcasted from the external electronic device is not received within the defined time interval, transmit, using the second communication circuitry, the control command such that the control command is delivered to the external electronic device.

5. The electronic device of claim 4, wherein the instructions, when executed by the at least one processor individually or collectively, cause the electronic device to:
based on identifying that the advertising packet broadcasted from the external electronic device is received within the defined time interval, identify reception intensity of a signal including the advertising packet broadcasted from the external electronic device;
based on identifying that the reception intensity of the signal is greater than reference intensity, broadcast, using the first communication circuitry, the advertising packet, including the control command, the identification information of the external electronic device, and the connection request, for allowing the external electronic device to provide the function corresponding to the control command before the communication link is established; and
based on identifying that the reception intensity of the signal is less than the reference intensity, broadcast, using the first communication circuitry, another advertising packet including the control command generated in accordance with the user input and the identification information of the external electronic device, without the connection request.

6. The electronic device of claim 1,
wherein the communication circuitry is first communication circuitry,
wherein the electronic device comprises second communication circuitry, and
wherein the instructions, when executed by the at least one processor individually or collectively, cause the electronic device to:
based on identifying that the communication link is not established between the electronic device and the external electronic device, identify, using the first communication circuitry, whether an advertising packet indicating that the communication link is not capable of being established between the electronic device and the external electronic device is received from the external electronic device within a defined time interval,
based on identifying that the advertising packet is not received from the external electronic device within the defined time interval, broadcast, using the first communication circuitry, the advertising packet, including the control command, the identification information of the external electronic device, and the connection request, for allowing the external electronic device to provide the function corresponding to the control command before the communication link is established, and
based on identifying that the advertising packet is received from the external electronic device within the defined time interval, transmit, using the second communication circuitry, the control command such that the control command is delivered to the external electronic device.

7. The electronic device of claim 1, wherein the instructions, when executed by the at least one processor individually or collectively, cause the electronic device to:
based on identifying that the communication link is not established between the electronic device and the external electronic device, periodically broadcast, using the communication circuitry, the advertising packet until the communication link is established between the electronic device and the external electronic device.

8. The electronic device of claim 1,
wherein the electronic device comprises a display,
wherein the instructions, when executed by the at least one processor individually or collectively, further cause the electronic device to:
display, using the display, a visual object for receiving the user input, and wherein the visual object:
based on the communication link having been established between the electronic device and the external electronic device, represents a first visual effect, and
based on the communication link not being established between the electronic device and the external electronic device, represents a second visual effect distinct from the first visual effect.

9. The electronic device of claim 1, wherein the control command generated in accordance with the user input includes a wake-up command to change a state of the external electronic device from a standby state to an activation state.

10. The electronic device of claim 1, wherein the identification information of the external electronic device includes a media access control (MAC) address of the external electronic device.

11. The electronic device of claim 1, wherein the instructions, when executed by the at least one processor individually or collectively, cause the electronic device to:
based on identifying that the communication link is not established between the electronic device and the external electronic device:
in accordance with a system resource of the electronic device capable of establishing the communication link between the electronic device and the external electronic device, broadcast, using the communication circuitry, the advertising packet, including the control command, the identification information of the external electronic device, and the connection request, for allowing the external electronic device to provide the function corresponding to the control command before the communication link is established; and
in accordance with the system resource of the electronic device not capable of establishing the communication link between the electronic device and the external electronic device, broadcast, using the communication circuitry, another advertising packet including the control command and the identification information of the external electronic device, without the connection request.

12. A method performed by an electronic device with communication circuitry, the method comprising:
receiving a user input for controlling an external electronic device registered in the electronic device;
identifying whether a communication link is not established between the electronic device and the external electronic device;
based on identifying that the communication link is not established between the electronic device and the external electronic device, broadcasting an advertising packet, including a control command generated in accordance with the user input, identification information of the external electronic device, and a connection request for establishing the communication link between the electronic device and the external electronic device, for allowing the external electronic device to provide a function corresponding to the control command before the communication link is established; and
based on identifying that the communication link has been established between the electronic device and the external electronic device, transmitting, using the communication circuitry to the external electronic device, via the communication link, a packet including the control command generated in accordance with the user input.

13. The method of claim 12,
wherein the user input is a first user input,
wherein the advertising packet is a first advertising packet, and
wherein the method further comprises:
after broadcasting the first advertising packet, receiving a second user input for controlling the external electronic device, and
based on the second user input being received before the communication link is established between the electronic device and the external electronic device in accordance with the connection request included in the first advertising packet, broadcasting a second advertising packet including a control command generated in accordance with the second user input and the identification information of the external electronic device, without the connection request.

14. The method of claim 12,
wherein the user input is a first user input,
wherein the advertising packet is a first advertising packet, and
wherein the method further comprises:
after broadcasting the first advertising packet, receiving a second user input for controlling the external electronic device, and
based on the second user input being received before the communication link is established between the electronic device and the external electronic device in accordance with the connection request included in the first advertising packet, broadcasting a second advertising packet including a control command generated in accordance with the second user input, the identification information of the external electronic device, and the connection request.

15. The method of claim 12,
wherein the communication circuitry is first communication circuitry,
wherein the electronic device comprises second communication circuitry, and
wherein the method comprises:
based on identifying that the communication link is not established between the electronic device and the external electronic device, identifying, using the first communication circuitry, whether an advertising packet broadcasted from the external electronic device is received within a defined time interval,
based on identifying that the advertising packet broadcasted from the external electronic device is received within the defined time interval, broadcasting, using the first communication circuitry, the advertising packet, including the control command, the identification information of the external electronic device, and the connection request, for allowing the external electronic device to provide the function corresponding to the control command before the communication link is established, and
based on identifying that the advertising packet broadcasted from the external electronic device is not received within the defined time interval, transmitting, using the second communication circuitry, the control command such that the control command is delivered to the external electronic device.

16. The method of claim 15, comprising:
based on identifying that the advertising packet broadcasted from the external electronic device is received within the defined time interval, identifying reception intensity of a signal including the advertising packet broadcasted from the external electronic device;
based on identifying that the reception intensity of the signal is greater than reference intensity, broadcasting, using the first communication circuitry, the advertising packet, including the control command, the identification information of the external electronic device, and the connection request, for allowing the external electronic device to provide the function corresponding to the control command before the communication link is established; and
based on identifying that the reception intensity of the signal is less than the reference intensity, broadcasting, using the first communication circuitry, another advertising packet including the control command generated in accordance with the user input and the identification information of the external electronic device, without the connection request.

17. The method of claim 12,
wherein the communication circuitry is first communication circuitry,
wherein the electronic device comprises second communication circuitry, and
wherein the method comprises:
based on identifying that the communication link is not established between the electronic device and the external electronic device, identifying, using the first communication circuitry, whether an advertising packet indicating that the communication link is not capable of being established between the electronic device and the external electronic device is received from the external electronic device within a defined time interval,
based on identifying that the advertising packet is not received from the external electronic device within the defined time interval, broadcasting, using the first communication circuitry, the advertising packet, including the control command, the identification information of the external electronic device, and the connection request, for allowing the external electronic device to provide the function corresponding to the control command before the communication link is established, and
based on identifying that the advertising packet is received from the external electronic device within the defined time interval, transmitting, using the second communication circuitry, the control command such that the control command is delivered to the external electronic device.

18. The method of claim 12, comprising:
based on identifying that the communication link is not established between the electronic device and the external electronic device, periodically broadcasting, using the communication circuitry, the advertising packet until the communication link is established between the electronic device and the external electronic device.

19. The method of claim 12,
wherein the electronic device comprises a display,
wherein the method further comprises, displaying, using the display, a visual object for receiving the user input, and
wherein the visual object:
based on the communication link having been established between the electronic device and the external electronic device, represents a first visual effect, and
based on the communication link not being established between the electronic device and the external electronic device, represents a second visual effect distinct from the first visual effect.

20. One or more non-transitory computer readable storage media storing one or more computer programs including computer-executable instructions that, when executed by at least one processor of an electronic device with communication circuitry individually or collectively, cause the electronic device to perform operations, the operations comprising:
receiving a user input for controlling an external electronic device registered in the electronic device;
identifying whether a communication link is not established between the electronic device and the external electronic device;
based on identifying that the communication link is not established between the electronic device and the external electronic device, broadcasting an advertising packet, including a control command generated in accordance with the user input, identification information of the external electronic device, and a connection request for establishing the communication link between the electronic device and the external electronic device, for allowing the external electronic device to provide a function corresponding to the control command before the communication link is established; and
based on identifying that the communication link has been established between the electronic device and the external electronic device, transmitting, using the communication circuitry to the external electronic device, via the communication link, a packet including the control command generated in accordance with the user input.
